(19) United States
(12) Patent Application Publication
(10) Pub. No.: US 2024/0354462 A1
(43) Pub. Date: Oct. 24, 2024

(54) PERCEPTION TESTING

(71) Applicant: Five Al Limited, Cambridge (GB)

(72) Inventors: Brian Gaffney, Cambridge (GB); Luis Barreto, Cambridge (GB); Roland Meister, Cambridge (GB)

(73) Assignee: Five Al Limited, Cambridge (GB)

(21) Appl. No.: 18/683,009

(22) PCT Filed: Aug. 10, 2022
(86) PCT No.: PCT/EP2022/072473

§ 371 Date: Feb. 12, 2024

(30) Foreign Application Priority Data
Aug. 12, 2021 (GB) 2111612.4

(51) Int. Cl. G06F 30/15

(52) U.S. Cl. CPC G06F 30/15

(57) ABSTRACT

A method of testing a candidate perception setup for an autonomous vehicle, comprising: receiving ground truth of a driving scenario run; providing a time-sequence of ground truth snapshots of the driving scenario run, wherein a decision making component independent of the ego agent determines a first time-sequence of decisions for the ground truth snapshots; providing a time-sequence of ablated snapshots of the driving scenario run, each ablated snapshot generated so as to cause a perception error that is representative of the candidate perception setup, wherein the decision making component determines a second time-sequence of decisions for the ablated snapshots; and computing a similarity measure between the first and second time-sequences of decisions denoting an extent to which the candidate perception setup caused a change in one or more decisions points of the second time-sequence relative to the first time-sequence, a decision point occurring when a decision changes between adjacent timesteps.

### TECHNICAL FIELD

The present disclosure pertains to systems and methods for testing a perception setup in a driving context.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Perception includes the interpretation of sensor data of one or more modalities, such as images, radar and/or lidar. Perception includes object recognition tasks, such as object detection, object localization and class or instance segmentation. Such tasks can, for example, facilitate the understanding of complex multi-object scenes captured in sensor data.

Autonomous vehicles are equipped with suitably programmed computers which are capable of processing data received from the sensors and making safe and predictable decisions based on the context which has been perceived by the sensors. An autonomous vehicle may be fully autonomous (in that it is designed to operate with no human supervision or intervention, at least in certain circumstances) or semi-autonomous. Semi-autonomous systems require varying levels of human oversight and intervention. An Advanced Driver Assist System (ADAS) and certain levels of Autonomous Driving System (ADS) may be classed as semi-autonomous. There are different facets to testing the behaviour of the sensors and control systems aboard a particular autonomous vehicle, or a type of autonomous vehicle.

A “level 5” vehicle is one that can operate entirely autonomously in any circumstances, because it is always guaranteed to meet some minimum level of safety. Such a vehicle would not require manual controls (steering wheel, pedals etc.) at all.

By contrast, level 3 and level 4 vehicles can operate fully autonomously but only within certain defined circumstances (e.g. within geofenced areas). A level 3 vehicle must be equipped to autonomously handle any situation that requires an immediate response (such as emergency braking); however, a change in circumstances may trigger a “transition demand”, requiring a driver to take control of the vehicle within some limited timeframe. A level 4 vehicle has similar limitations; however, in the event the driver does not respond within the required timeframe, a level 4 vehicle must also be capable of autonomously implementing a “minimum risk maneuver” (MRM), i.e. some appropriate action(s) to bring the vehicle to safe conditions (e.g. slowing down and parking the vehicle). A level 2 vehicle requires the driver to be ready to intervene at any time, and it is the responsibility of the driver to intervene if the autonomous systems fail to respond properly at any time. With level 2 automation, it is the responsibility of the driver to determine when their intervention is required; for level 3 and level 4, this responsibility shifts to the vehicle's autonomous systems and it is the vehicle that must alert the driver when intervention is required.

Safety is an increasing challenge as the level of autonomy increases and more responsibility shifts from human to machine. In autonomous driving, the importance of guaranteed safety has been recognized. Guaranteed safety does not necessarily imply zero accidents, but rather means guaranteeing that some minimum level of safety is met in defined circumstances. It is generally assumed this minimum level of safety must significantly exceed that of human drivers for autonomous driving to be viable.

According to Shalev-Shwartz et al. “On a Formal Model of Safe and Scalable Self-driving Cars” (2017), arXiv:1708.06374 (the RSS Paper), which is incorporated herein by reference in its entirety, human driving is estimated to cause of the order 10⁻⁶ severe accidents per hour.

On the assumption that autonomous driving systems will need to reduce this by at least three order of magnitude, the RSS Paper concludes that a minimum safety level of the order of 10-9 severe accidents per hour needs to be guaranteed, noting that a pure data-driven approach would therefore require vast quantities of driving data to be collected every time a change is made to the software or hardware of the AV system.

The RSS paper provides a model-based approach to guaranteed safety. A rule-based Responsibility-Sensitive Safety (RSS) model is constructed by formalizing a small number of
“common sense” driving rules:
1. Do not hit someone from behind.
2. Do not cut-in recklessly.
3. Right-of-way is given, not taken.
4. Be careful of areas with limited visibility.
5. If you can avoid an accident without causing another one, you must do it.”

The RSS model is presented as provably safe, in the sense that, if all agents were to adhere to the rules of the RSS model at all times, no accidents would occur. The aim is to reduce, by several orders of magnitude, the amount of driving data that needs to be collected in order to demonstrate the required safety level.

A safety model (such as RSS) can be used as a basis for evaluating the quality of trajectories that are planned or realized by an ego agent in a real or simulated scenario under the control of an autonomous system (stack). The stack is tested by exposing it to different scenarios, and evaluating the resulting ego trajectories for compliance with rules of the safety model (rules-based testing). A rules-based testing approach can also be applied to other facets of performance, such as comfort or progress towards a defined goal.

### SUMMARY

A perception setup refers to a particular hardware and/or software configuration for a perception system. A hardware configuration could, for example, include a particular choice and physical arrangement of sensors on a vehicle. A software setup could include a particular choice and configuration of perception components that would operate on sensor data.

Planning systems for autonomous vehicles rely on perception for observing the driving environment, including the structure and layout of the road, as well as the current behaviour of other agents, which is in turn used for predicting future behaviour of agents on the road. A given perception setup therefore needs to be sufficient to support the decision making of an autonomous vehicle system.

The adequacy of a given perception setup can be tested by implementing the perception setup and evaluating the quality of the ego actions generated based on the prediction and planning components of the AV system. However, this can lead to waste of computing resources by running planning systems in situations where the underlying perception setup is insufficient to support the planner, for example where a sensor arrangement does not provide sufficient coverage of the driving environment. It may also be desirable to evaluate a perception configuration in the absence of a full prediction and planning system, for example in the early stages of development of an AV stack.

Disclosed herein are systems and methods for testing a perception configuration in a driving context, in order to assess whether the perception configuration would be adequate to support a decision-making task on-board a vehicle.

The present techniques are designed so that they can be implemented at an early stage of development, which simplifies and speeds up the development process for vehicles with autonomous functions.

A first aspect herein is directed to a computer-implemented method of testing a candidate perception setup for an autonomous vehicle, the candidate perception setup tested using a decision making component to assess suitability of the candidate perception setup in terms of its effect on driving decisions, the method comprising:
receiving ground truth of a real or simulated driving scenario run, in which an ego agent operated independently of the decision making component and independently of the candidate perception setup;
providing, to the planning system, a time-sequence of ground truth snapshots of the driving scenario run, wherein for each ground truth snapshot, the decision making component decides a first ego action for the ego agent, thereby determining a first time-sequence of decisions for the ground truth snapshots;
providing, to the planning system, a time-sequence of ablated snapshots of the driving scenario run, each ablated snapshot generated based on the ground truth and the candidate perception setup, so as to cause, in the ablated snapshot, perception error that is representative of the candidate perception setup, wherein for each ablated snapshot, the decision making component decides a second ego action for the ego agent, thereby determining a second time-sequence of decisions (decided ego actions) for the ablated snapshots; and
computing a similarity measure between the first time-sequence decisions and the second time-sequence of decisions, the similarity measure denoting an extent to which the candidate perception setup caused a change in one or more decisions points of the second time-sequence of decisions relative to the first time-sequence of decisions, a decision point occurring when a decision changes between adjacent timesteps.

In embodiments, the method may comprise identifying one or more first decision points in the first time-sequence of decisions and identifying one or more second decision points in the second time-sequence of decisions, and comparing the first decision point with the second decision points to compute the similarity measure.

Alternatively, the similarity measure may capture decision point information implicitly. For example, the decision component may decide whether or not the action is safe at each time step. For example, consider the following two binary sequences of decisions:

| Time step: | 0 | 1 | 2 | 3 | 4 | 5 | 6 | 7 |
|---|---|---|---|---|---|---|---|---|
| Ground truth: | (unsafe, | unsafe, | unsafe, | unsafe, | safe, | safe, | safe, | safe) |
| Ablated: | (unsafe, | unsafe, | safe, | safe, | safe, | safe, | safe, | safe) |

There is a single decision point in each sequence, occurring at time step 4 for the ground truth sequence, and time step 2 for the ablated sequence.

A simple metric might be computed as the sum of differences between the sequences—equal to two in this case. The sum of differences captures the extent of deviation in time between the corresponding decision points, without explicitly identifying those decision points.

The first time sequence of decisions may comprise a binary indicator for the first ego action at a time step corresponding to each ground truth snapshot, and the second time sequence of decisions may comprise a binary indicator for the second ego action at a time step corresponding to each ablated snapshot. Alternatively, each decision of the first and second time series may comprise a non-binary indicator for the corresponding ego action at a time step corresponding to each ground truth or ablated snapshot.

The decisions of the first and second time-series of decisions may comprise one of: an indicator of safety of the respective ego action for each ground truth or ablated snapshot; an indicator of driver attentiveness for each ground truth or ablated snapshot; and an indicator for emergency airbag deployment for each ground truth or ablated snapshot.

A user interface, e.g., graphical user interface (GUI), may be provided for defining the candidate perception set up. This could allow facets of the perception setup to be configured, such as sensor placement, sensor field of view etc. as well as software elements using appropriate perception error models (see below for further details).

In software, perception errors could be introduced by generating sensor-realistic synthetic sensor data in simulation and passing this through a candidate perception system. However, this requires the perception system to be fully built, and requires high-fidelity synthetic sensor data. As an alternative, a perception error model may be used to ‘ablate’ (inject perception error into) low-fidelity ground truth inputs, which does not require high fidelity sensor data (see below for further examples).

For each of the ground truth snapshots and ablated snapshots, the decision making component may decide a first or second ego action for the ego agent based on a motion model applied to the ego agent and/or other agents of the ground truth or ablated snapshot. The motion model may assume that the ego agent and/or other agents present in the ground truth or ablated snapshot travel at a constant velocity.

The first and second time sequences of decisions may be used to generate an output at a user interface indicating one or more decisions points of the first time-sequence of decisions and one or more decision points of the second time-sequence of decisions.

A second aspect herein is directed to a computer-implemented method of testing a candidate perception setup for an autonomous vehicle, the candidate perception setup tested using a decision making component to assess suitability of the candidate perception setup in terms of its effect on driving decisions, the method comprising:
providing to the decision making component a baseline driving scene, wherein the decision making component classifies a driving action based on the baseline driving scene, in relation to a predefined set of decision classes;
providing to the decision making component an ablated driving scene, which corresponds in time to the baseline driving scene, and includes perception error representative of the candidate perception setup, wherein the decision making component classifies the driving action based on the ablated driving scene, in relation to the predefined set of decision classes;
comparing the classification of the baseline driving scene with the classification of the ablated driving scene, to determine whether the driving action was assigned a different decision class for the ablated driving scene than the baseline driving scene.

The comparison may be performed in order to generate an output at a user interface for comparing the effect of the perception error on decision making by the decision making component. For example, the output may take the form of a similarity measure, indicating extent of similarity in driving decisions.

The method may be performed at each of multiple time steps of a driving scenario, on first and second time sequences of baseline and ablated driving scenes derived from the driving scenario. The output may be an aggregated output, computed over the multiple timesteps.

The method may be performed over multiple scenarios, in order to identify a subset of one or more scenarios in which the extent of difference is greatest.

The terms driving decision and driving action are used in a broad sense, and include decisions about secondary driving functions such as triggering a driver alert, deploying an airbag etc., as well as planning decisions such as maneuver evaluation. The terms driving-relates decision/actions may also be used to refer to the same.

Further aspects herein provide a computer program comprising one or more computers configured to implement any of the above methods, and computer program code for programming a computer system to implement the same.

### BRIEF DESCRIPTION OF FIGURES

For a better understanding of the present disclosure, and to show how embodiments of the same may be put into effect, reference is made to the accompanying figures in which:

FIG. 1A shows a schematic function block diagram of an autonomous vehicle stack;

FIG. 1B shows a schematic overview of an autonomous vehicle testing paradigm;

FIG. 1C shows a schematic block diagram of a scenario extraction pipeline;

FIG. 2 shows a schematic block diagram of a testing pipeline;

FIG. 2A shows further details of a possible implementation of the testing pipeline;

FIG. 3A shows an example of a rule tree evaluated within a test oracle;

FIG. 3B shows an example output of a node of a rule tree;

FIG. 4A shows an example of a rule tree to be evaluated within a test oracle;

FIG. 4B shows a second example of a rule tree evaluated on a set of scenario ground truth data;

FIG. 4C shows how rules may be selectively applied within a test oracle;

FIG. 5 shows a schematic block diagram of a visualization component for rendering a graphical user interface;

FIGS. 5A, 5B and 5C show different views available within a graphical user interface;

FIG. 6A shows a first instance of a cut-in scenario;

FIG. 6B shows an example oracle output for the first scenario instance;

FIG. 6C shows a second instance of a cut-in scenario;

FIG. 6D shows an example oracle output for the second scenario instance;

FIG. 7 shows a representation of a moving object within a simulation interface;

FIG. 8 shows a set of error plots for attributes of an object within a scenario;

FIG. 9 shows an example configuration for a perception error model;

FIG. 10 shows a schematic block diagram of an example perception evaluation system;

FIG. 11 shows an example scenario in which a lane change event is assessed;

FIG. 12 shows an example interface for comparing an event assessment between ground truth and perception snapshots; and

FIG. 13 shows an example graphical user interface showing the evaluation of rules and events for a driving scenario.

### DETAILED DESCRIPTION

A “full” autonomous vehicle stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

The term “stack” can also refer to individual sub-systems (sub-stacks) of the full stack, such as perception, prediction, planning or control stacks, which may be tested individually or in any desired combination. A stack can refer purely to software, i.e. one or more computer programs that can be executed on one or more general-purpose computer processors.

Whether real or simulated, a scenario requires an ego agent to navigate a real or modelled physical context. The ego agent is a real or simulated mobile robot that moves under the control of the stack under testing. The physical context includes static and/or dynamic element(s) that the stack under testing is required to respond to effectively. For example, the mobile robot may be a fully or semi-autonomous vehicle under the control of the stack (the ego vehicle). The physical context may comprise a static road layout and a given set of environmental conditions (e.g. weather, time of day, lighting conditions, humidity, pollution/particulate level etc.) that could be maintained or varied as the scenario progresses. An interactive scenario additionally includes one or more other agents (“external” agent(s), e.g. other vehicles, pedestrians, cyclists, animals etc.).

The following examples consider applications to autonomous vehicle testing. However, the principles apply equally to other forms of mobile robot.

Embodiments will now be described by way of example only.

In the context of autonomous vehicle testing and design, the present techniques can be used to test different perception setups (also referred to herein as perception configurations), without having to physically implement those different setups in the real-world. The described techniques use a form of “downstream” testing, in which a perception setup is tested in terms of its effect on driving decisions. The described techniques allow different perception setups to be tested before any planning system has been decided. Moreover, the described techniques are instead based on a comparison of discrete, higher level “decision points”.

Given a current “snapshot” of a driving scenario at some point in time (also referred to as a driving scene or frame) and an action to be evaluated, a decision component classifies the action as belonging to a decision class from a predefined set of decision classes. The decision component is rules-based in the following examples, made by evaluating one or more decision rules (e.g. driving safety rule(s)—see below).

The decision classes may be binary, e.g. with only two possible decision classes indicating whether or not the action is permitted (referred to as “pass” and “fail” respectively). This binary classification constitutes a decision as to whether or not the action could be performed at the current point in time. Determining whether an action is permitted would typically consider safety and may consider other facets of driving performance (comfort, progress etc.). For example, in a lane driving scenario, given a snapshot of the scenario, the decision component may decide whether or not a lane change maneuver is safe/permitted. Alternatively, the decision classes may be non-binary (more than two). For example, an emergency braking action might have multiple levels of severity, depending on the time available to come to a halt (e.g. low, medium and high). In this case, the decision classes could be the different levels of severity, and the decision making component may decide which level of severity is appropriate (the decision class in this case) given a current snapshot.

In the following examples, the decision component is applied to a sequence of snapshots of an evolving scenario over a sequence of time steps. In this context, a decision point refers to a time step at which a change in decision class occurs, relative to the previous time step. For example, a lane change maneuver might be classed as unsafe in one timestep and safe in the next timestep, representing a lane change decision point. As another example, it might be decided that medium-severity emergency braking is appropriate one time step, but that high-severity emergency braking is required in the next step (one possible emergency raking decision point).

The comparison is on decision classes or decision points between ground truth and the perception configuration under consideration. A ‘baseline’ view of the scenario is provided, in the following examples, by a first “ground truth” snapshot of the scenario. A second snapshot (ablated) at the same point in time includes perception error that is representative of the perception configuration under consideration, reflected in modified agent states (position, velocity etc.), missed detections (false negatives), ghost detections (false positives) etc. relative to the ground truth snapshot. The question of whether or not that perception error is significant is assessed in terms of decisions, i.e., whether or not the perception error causes a change in decision class relative to ground truth. Over the course of the scenario, decision points provide a useful indicator of overall impact on driving performance: for example, if a decision point occurs at timestep n on a sequence of ground truth snapshots (e.g. a lane change maneuver is first classed as safe, having previously been classed as unsafe), and occurs at the same time step n in a corresponding sequence of ablated snapshots, that indicates the presence of perception error is immaterial for that decision point. However, if the decision point occurs earlier on the ablated snapshots, e.g. because the perception configuration has caused a missed or occluded detection, that is a safety issue: the perception configuration has caused an unsafe decision, in making the lane change maneuver appears safe when it is not. Conversely, if the decision point occurs later than step n on the ablated snapshots, that indicates a hesitancy issue: the perception error has caused the lane change decision point to be delayed unnecessarily.

The comparison is in decision classes or decision points, not trajectories. The method does not require trajectories to be determined or synthesised using the candidate perception setup. In the examples below, an action is classified against a given snapshot at time step n by “rolling forward” from the current snapshot to some appropriate later time using some motion model(s), and assessing the outcome.

Simple motion models may be used for this purpose. For example, in a lane change scenario, an end position of an ego agent after a predetermined maneuver interval (e.g. 4 seconds) may be determined, which places the ego agent centrally in a target lane. The other agents may be assumed to move with constant velocity in that e.g. 4 second interval, allowing their end positions to be determined based on their velocities given in the snapshot at time n. A decision rule or rule set may then be evaluated at the end of the window, e.g. whether the ego agent is a safe distance from all other agents at the end of the e.g. 4 second window. Here, the decision class is decided based on a single evaluation, e.g. 4 second after the current snapshot (this does not pick up the edge case that something unsafe happened during the maneuver but the end state was safe, but this is very rare in practice).

A snapshot at timestep n refers to a view of the scenario at or up to time n. In the examples below, the snapshot includes only current state data (e.g. agent states at time n). However, the snapshot could include historic data (e.g. states prior to time n).

The method is “open loop”, in that neither its decisions taken on the basis of ground truth snapshots, nor those taken on the ablated snapshots, influence the driving scenario.

The main examples described herein pertain to planning, with the decision making component operating as “rules-based” planner. Other use cases are considered later. The starting point for the test is a scenario run that has occurred in a simulation environment or in the real world. The scenario includes an ego agent that took certain decisions over the course of that run, manifesting as an ego trace (sequence of spatial and motion states). The ego agent could be a simulated agent, or a real vehicle (autonomous or manually driven). A typical scenario would include a static road layout which the ego agent was required to navigate (autonomously or under the control of a human driver). The method is open loop, in the sense that the rules-based planner and the candidate perception setup have no influence on the behaviour of the ego agent in the scenario run.

Safety models have been used in autonomous driving to precisely define the concept of “safe”. Examples of known safety models include the Responsibility-Sensitive Safety (RSS) and the Automated Lane Keeping Specification (ALKS) being developed by the UK government. Within a testing pipeline, a safety model can be used as a basis for rules-based testing of driving performance, in terms of well-defined numerical quantities such as lateral or longitudinal distance (e.g., between two agents, or relative to a road reference point or line etc.). Rules-based testing can be extended to other facets of driving performance, such as progress and comfort. In such systems, a “test oracle” applied some predefined driving rule set to a given scenario run (which could be real or simulated). This would normally be applied to some ground truth representation of the scenario (e.g., the simulator ground truth for a simulated scenario, or pseudo-ground truth obtained though manual annotation and/or offline processing of a real scenario run). The test oracle would determine, in accordance with the predetermined driving rules, whether or not an ego agent behaved acceptably over the course of a scenario (e.g., by providing a time sequence of “pass/fail” results for each rule).

In the present context, driving rules are re-purposed to provide a rules-based planner operating in a form of “shadow mode”. Shadow mode sometimes implies an autonomous system operating in the background, on board a human-driven vehicle. However, here the term is used in a broader sense, to mean any open loop decision making (that is, decision making that is based on some scenario but does not affect the behaviour of the ego agent in that scenario). The purpose of the rules-based planner is not to assess the performance of the ego agent in a scenario run. Rather, the scenario run is simply used to provide static “snapshots” of the scenario. Given a snapshot and a desired objective, the rules-based planner provides an assessment as to whether that objective is permitted (e.g., safe or, more generally, permitted by the driving rule set) given that snapshot. The point at which a given objective changes from unpermitted to permitted is one type of “decision point” considered herein.

A “perception setup” refers to a particular hardware and/or software configuration for a perception system. A hardware configuration could, for example, include a particular choice and physical arrangement of sensors on a vehicle. A software setup could include a particular choice and configuration of perception components that would operate on sensor data. The perception setup need not be physically realized, nor does it necessarily need to be modelled in the traditional sense of building sensor models to provide high-fidelity synthetic sensor data to perception components. In the described examples below, the perception system is modelled using a “surrogate” perception system that takes low-fidelity ground truth inputs and does not require high-fidelity synthetic sensor data. The ground-truth inputs are said to be “ablated” by the surrogate model introducing perception error that is representative of the perception setup under consideration.

For the purpose of comparison, two sequences of decision points are generated in an open-loop fashion, using the rules-based planner.

The first sequence of decision points is generated based on a sequence of ground truth (non-ablated) snapshots of the scenario run. These are obtained directly from the scenario ground truth, without the addition of perception error (where pseudo-ground truth is used, this is not a “perfect” representation in the same way as simulated ground truth. However, for the purposes of testing, the available ground truth is taken as a baseline, and error indicates error relative to this baseline unless otherwise indicated).

The second sequence of decision points is generated based on snapshots that are ablated in accordance with the perception setup under testing. This is quite different from a typical “test oracle” use case; a test oracle would normally only be applied to scenario ground truth (or its closest proxy), in order to provide an “external” assessment of driving performance that is not influenced by perception errors and the like. The ablation may affect when decision points occur and/or which decision points occur, as the rules-based planner is now operating on an imperfect (and more realistic) view of the scenario.

If the two series of decision points are similar, that similarity implies that the rules-based planner is able to (more or less match) its own ground truth performance with the candidate perception setup, which in turn indicates that this set up is highly suitable for the particular scenario under consideration. By testing over a range of scenarios within an operational design domain under consideration, and finding scenarios with the greatest divergence between ablated and ground truth decisions points, a given perception setup can be robustly tested before it is finalized.

Note that the ego agent itself will not necessarily pass all of the driving rules all of the time, or may be otherwise non-optimal. The sequence of ground truth decision points derived by the rules-based planner is not necessarily optimal (although it is, by definition guaranteed to be safe), nor will it necessarily reflect the actual decisions taken by the ego agent over the course of the scenario run (e.g. a scenario might be used to evaluate the safety of a lane change maneuver, on both ground truth and ablated inputs. However, the lane change maneuver may or may not be performed in the scenario itself). Those considerations are not germane in the present context. The described approach does not assume that the ground truth decision points are truly optimal, only that they are optimal given the actual behaviour of the ego agent in the scenario run.

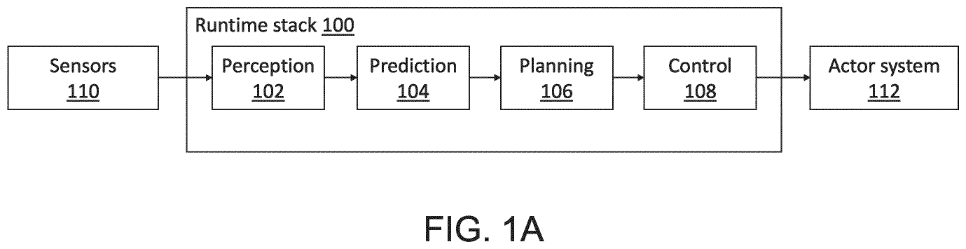

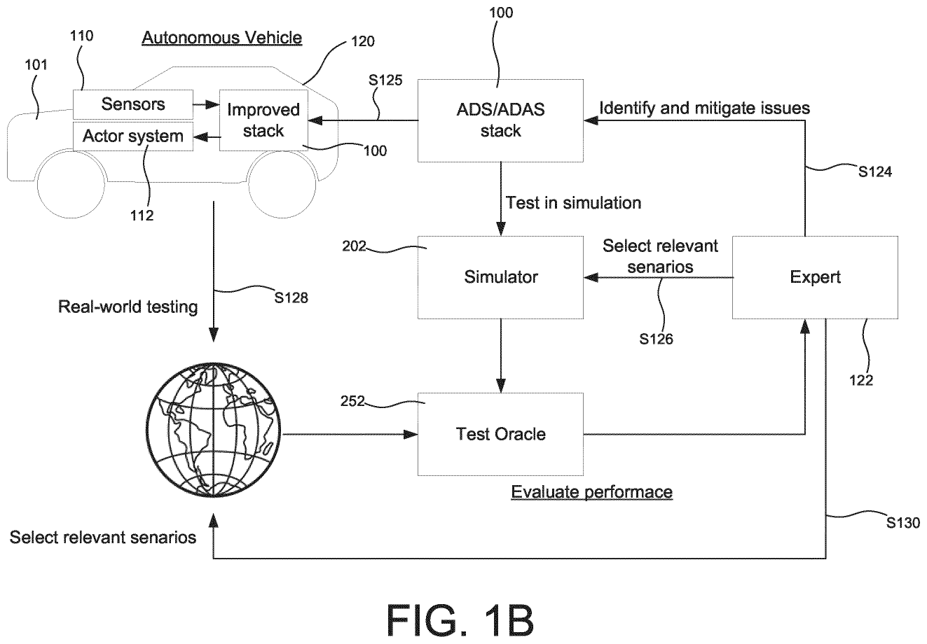

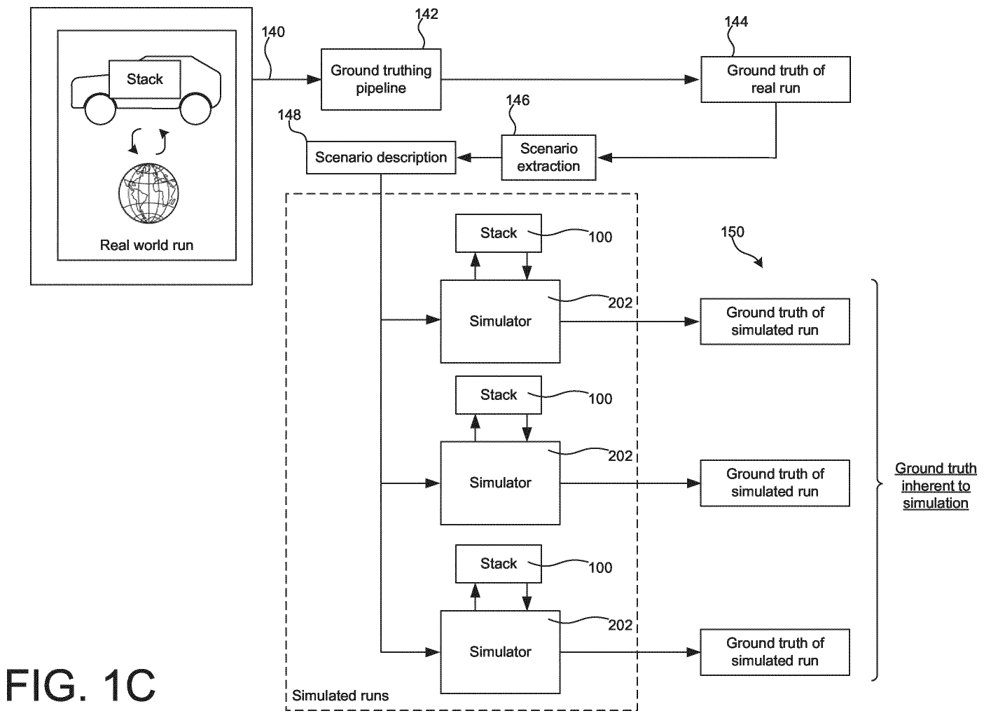

Described below is a testing framework for testing components of an autonomous vehicle. As mentioned above, one possible application of the present disclosure is to test a perception setup for its ability to support prediction and planning elements of an AV stack, described below with reference to FIG. 1A. As described in more detail below, this can be implemented by applying rule-based testing in a ‘shadow mode’ or ‘open loop’ to a snapshot of the scenario as determined by the given perception configuration to decide an action for the ego vehicle at that snapshot based on that perception setup, and comparing this with the decisions for a corresponding ‘ground truth’ snapshot. This differs from testing in which the AV stack is evaluated by applying rules to a sequence of actual ‘ground truth’ ego actions taken based on the AV stack's prediction and planning components. The application of rules-based testing to snapshots of a scenario to evaluate particular perception configurations without requiring full prediction and planning functionality is described below. This can be implemented as part of a rule-based testing framework in which a ‘test oracle’ is used to apply rules and metrics to evaluate part or all of an autonomous vehicle stack. Further details of a rule-based testing framework in which both ego traces and perception configurations can be evaluated are described later with reference to FIGS. 1A-6D.

Described below is a method of evaluating a perception system by applying rule-based testing to outputs of a perception error model of the perception system and comparing the results to results obtained by applying the same rules to a ‘ground truth’ for the same scenario. Perception error models may be used as surrogate models for real perception systems and evaluation of the perception error model provides an insight into the performance of the real perception system.

Perception error models will now be described in more detail, before describing an example implementation of the above-mentioned rule-based evaluation technique.

Perception error models (PEMs) act as a surrogate for a given real-life perception system. A perception system may comprise a set of sensors with a particular configuration, and a perception component configured to take data from the sensors as input and determine a perception output which contains predicted information about the environment captured in the sensor data, such as, for example, shapes, locations, orientations, and motion of vehicles in a driving scenario. Each of these is associated with an error, since the perception system is not able to detect and locate every object of the scene with perfect accuracy. This error could be dependent on a number of variables, such as weather conditions, lighting, and occlusion, among others.

Testing of autonomous vehicles and other systems relying on perception is often done in simulation. To generate realistic perception outputs of a given perception system in simulation, perception error models may be used. Instead of applying the perception system itself to simulated sensor data, which can be unrealistic, a perception error model can perform ‘low-fidelity’ simulation of the relevant aspects of the scene necessary for planning, such as the position, orientation, extent, etc. of objects in the scene, as well as detection errors and occlusion due to relative positions of objects and sensors. A scenario may be defined based on a high-level ‘ground truth’ description of the scenario, which may include, for example, a set of bounding boxes with a 6D pose—i.e. location and orientation in 3D space representing objects in the scene. The output of the real perception system based on this ground truth can be modelled by applying statistically representative errors to attributes of the ground truth.

The simulator can output two Open Simulation Interface (OSI) messages to represent objects in a scene (such as agents of a driving scenario): a ‘ground truth’ message, which gives the true state of objects in the scene, and a ‘sensor data’ message, which gives the perceived state of all objects along with ‘sensor view’ messages for each individual sensor, where the perception system being modelled takes inputs from a configuration of multiple sensors. The ‘sensor data’ message is created using the PEM, which can be configured to add errors to agents to implement low-fidelity, fast perception surrogate models approximating the error statistics of a real perception system, as described above, as well as to perform sensitivity analysis, where the magnitude and type of errors are varied to determine their influence on a system's response to a scenario.

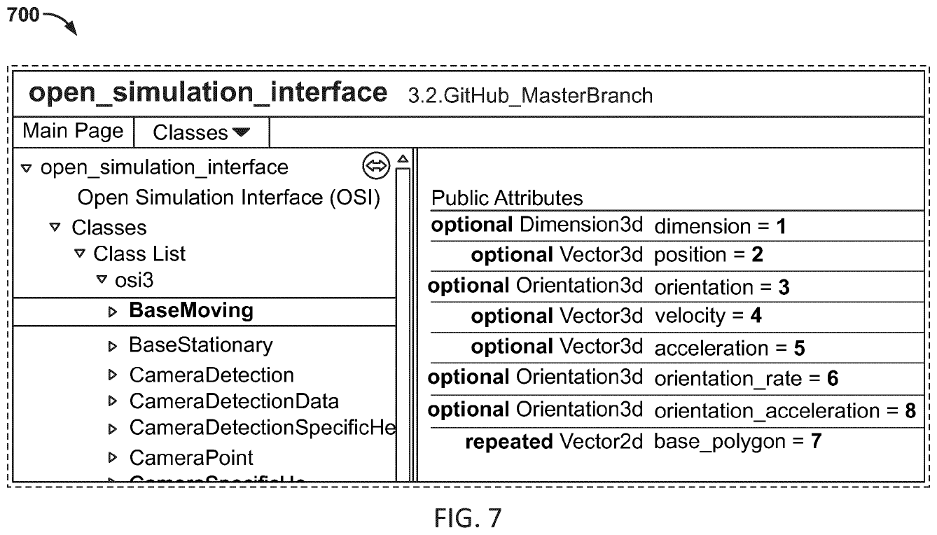

FIG. 7 shows how a moving object can be represented within a simulation interface, referred to as ‘Open Simulation Interface’ 700. The BaseMoving class has a set of attributes, such as dimension, position, orientation, velocity and acceleration. The perception error model provides a set of estimated detections for the object in a scenario, by applying errors to any attribute of the class for the object. The perception error model may also include time dependence and distance dependence for each of the attributes. The perception error model may also include missed detections, where a ground truth object does not appear at all in the modelled perception output, and ghost detections, where an object not present in the scenario appears in the modelled perception output. This is because perception systems often miss detections or see objects that are not actually present due to various factors such as occlusion, weather conditions or poor lighting. ‘Perception error’ as used herein refers to both errors in individual object attributes provided by the error model, such as a positional error, as well as false positives and false negatives (i.e. missed and ghost detections). For example, errors may be added to the position attribute in the x dimension by adding gaussian noise, defining the parameters of the gaussian distribution as part of the perception error model.

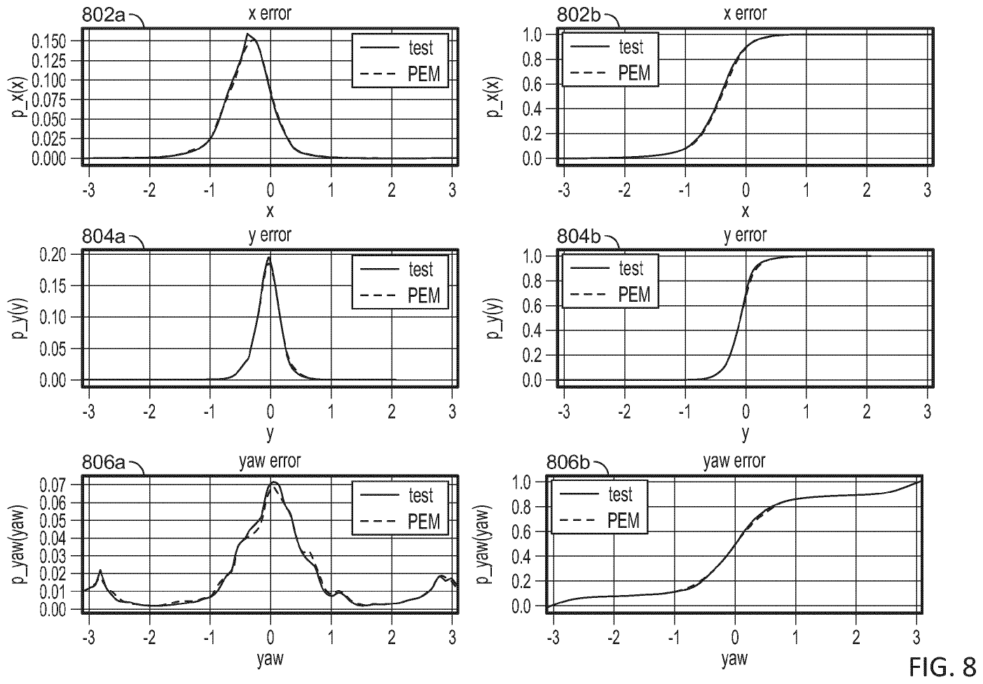

As shown in FIG. 8, the perception error model generates errors which are statistically representative of the perception system being modelled. In the simple example shown in FIG. 8, the PEM is used as a surrogate model predicting pose errors of a real perception system. The PEM may be fit to a training dataset which contains the output statistics of the real perception system. The PEM output can then be compared with the outputs of the perception system on a held-out test dataset. The graphs of FIG. 8 show the distribution of pose errors in the x- and y-directions as well as errors in the yaw angle for the test dataset. The distribution of pose errors predicted by the PEM and the pose errors of the actual perception system on the test data are plotted on a common set of axes. For errors of each of the x-dimension (802a, 802b), y-dimension (804a,804b) and yaw angle (806a,806b), the distribution of errors is shown both as a probability density (left) and as a cumulative distribution (right). The PEM provides very similar error statistics, and can therefore be used to generate realistic perception errors in simulation at a greatly reduced cost compared with running the real perception system on simulated data.

This can be a more lightweight solution to simulating sensor data and applying the perception system itself, since it bypasses the rendering of simulated sensor outputs and avoids the issue of the perception system performing differently on simulated sensor data than on real sensor data, since the PEM models the perception of the sensor data based on a high-level ground truth description of the scenario.

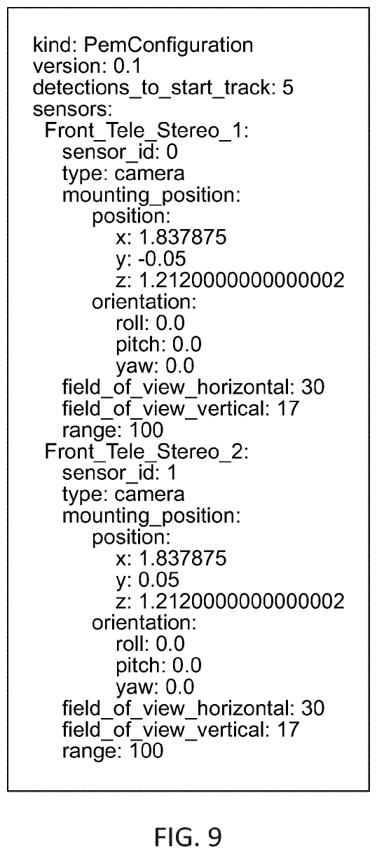

FIG. 9 shows how a PEM configuration is defined for modelling a perception system using a multi-sensor configuration, for example where a set of different sensors are mounted to different physical locations of an autonomous vehicle. Contents of a configuration YAML file are shown in FIG. 9. For each sensor, the PEM configuration specifies the type of sensor, e.g. camera, lidar, etc., the mounting position and orientation in 3D relative to a reference position of the vehicle, and the field of view provided by the sensor in the horizontal and vertical directions, as well as the range of the sensor (the distance at which things are still captured in the sensor data). This configuration provides the PEM with the physical configuration of the sensors collecting the sensor data to be modelled. The PEM may then be applied to generate perception errors consistent with the defined multi-sensor configuration. In an example configuration, where most sensors are configured to collect data in front of the vehicle, a sparser arrangement of sensors directed behind the vehicle may cause detections to be missed due to occlusions in a particular field of view that cannot be overcome by combining multiple sensor outputs.

The field of view of each sensor may be shown in a user interface, with a 3D representation of the vehicle to which the sensors are mounted, and rays of different colours showing the field of view and range of the sensors. The configuration defined in the configuration file may be adjusted based on user inputs received at the graphical user interface.

### Open-Loop Evaluation

Accuracy of perception outputs affects the performance of a vehicle. Where a full vehicle stack comprising perception and planning components are being tested, the performance of the stack as a whole is typically evaluated based on the planned trajectories determined by a planning component. However, there are some use cases in which it is useful to evaluate the likely actions taken based on a set of perception outputs without implementing a full planner. This may occur, for example, in the case where a vehicle is equipped with a set of sensors and an optimal configuration of sensors is required that provides the best possible coverage of the environment based on which a vehicle stack may be built, but for which no planner is available. For this and other use cases where a planner output is not available or desirable, a rule-based evaluation of perception may instead be implemented.

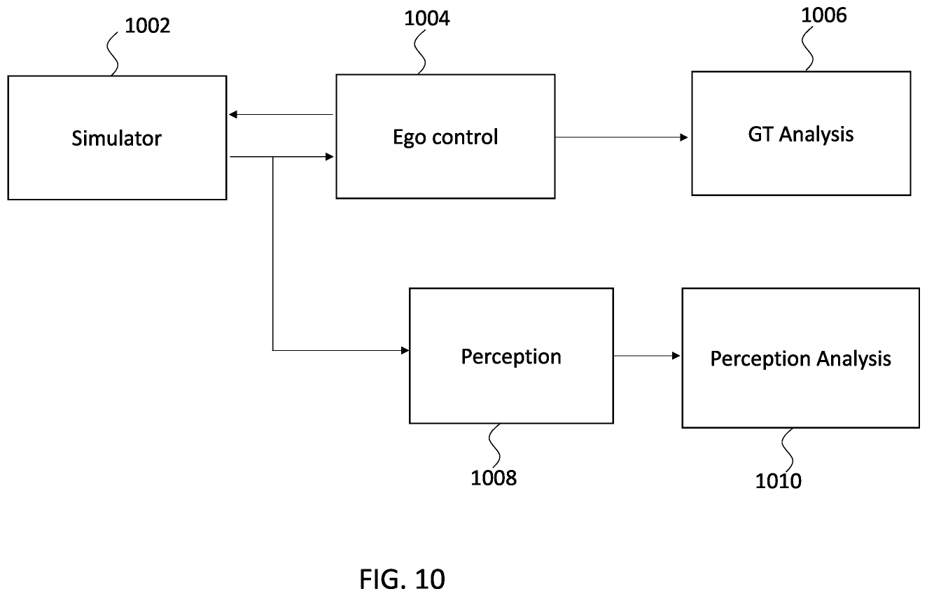

FIG. 10 shows how an ‘open-loop’ perception evaluation technique may be implemented to evaluate both the ground truth and a modelled perception output for a set of simulated scenarios, where the modelled perception output is an estimated output for a perception system using one or more sensors. The simulator 1002 provides a ground-truth driving scenario, defining the states of a set of agents in a scene and an ego vehicle. The simulator 1002 may use a full autonomous vehicle stack to plan ego actions and simulate ego control 1004 over the duration of the driving scenario. Alternatively, a ground truth scenario may be extracted from a real world driving run, in which case ‘ego control’ 1004 is carried out by the driver of the vehicle in the real driving run. The simulation of the scenario is not dependent on the perception model 1008 shown. The perception model 1008 simulates the perception system outputs. The perception system may be a perception error model as described above, or any other sensor simulator. The ground truth, which, as described above, can comprise a set of objects and attributes such as position, orientation, velocity, etc. over the course of the scenario, is analysed in a ground truth analysis 1006, by applying one or more rules to determine if certain actions would be safe at various points of the simulated scenario. The decision of whether a given action is safe may be defined as an ‘event’ within a rule-based framework. A corresponding perception analysis 1010 is applied to the output of the perception system, which models how the scenario is observed by the sensor configuration being modelled. This determines, for example, whether certain actions would be deemed safe based on the perception of the vehicle at various points of the simulated scenario. Examples of rules used in this analysis will be described below, but the purpose of the rule-based analysis in the absence of a planner is to evaluate decision points of the ego vehicle for safety based on simple assumptions, rather than evaluating a planned trajectory.

The ground truth evaluation and the perception evaluation are compared to determine where the perception model has provided an output indicating that a given action is safe where the ground truth evaluation shows that it is not. If this happens, it may be an indication that the perception system is performing poorly on this particular scenario. As described above, this type of evaluation may be used to determine an optimal sensor configuration, and more generally the perception system settings. For example, a camera neural network (NN) might provide detections, but a tracker will track over multiple frames. A parameter of the trackers which is challenging to tune is the number of detections before the tracker claims the detections are correct. Too low, and false positives go to the planner; too low and the delay between first seeing an object and it going to the planner is too high. This parameter can form part of the perception setup, to test different values before the perception system is finalized (and possibly before it is fully built, using appropriate model(s)).

To evaluate a perception configuration, it may be re-run over a number of different simulated scenarios, say, 100 or 1000 simulations. The evaluation of the ground truth and perception may be compared in each case and it may be found that the perception system incorrectly classifies the safety of an action in 10% of cases. Here, the metric of interest is the amount of time that the perception system gives a different result ground truth. Evaluating a perception model for an alternative configuration of the sensors against the evaluation of the ground truth scenarios for a similar set of simulations may find that a difference between the ground truth evaluation output and the perception evaluation output only occurs 2% of the time. This is an indication that the second sensor configuration provides a more accurate representation of the scenario based on which the ego could more safely make decisions. In addition to a mean or total proportion of ‘errors’ between the perception and ground truth evaluations, a standard deviation may be computed to show how the perception assessment varies over the multiple simulations. A distribution of the difference percentage may be constructed.

It is important to note that the perception output is not returned to the simulator and does not affect the scenario ground truth, and is thus referred to as ‘open-loop’ perception. This allows like-for-like comparison of different perception system configurations without affecting the scenarios.

The evaluation may be carried out for one type of maneuver or event, such as a lane-change. For each simulation, both the ground truth scenario and the perception model output are evaluated at every timestep for whether a lane change is safe. Where the perception output provides a different result to the ground truth, this may indicate either that the perception system has a weakness or limitation causing objects to be misdetected or that the scenario itself is outside of an operational design domain (ODD) for the vehicle. An ODD is the subset of possible scenarios in the world in which the vehicle is required to perform. As mentioned above, if after analysing the perception on a set of multiple simulations, the perception model differs from the ground truth in a significant proportion of cases this may be an indication to adjust the sensor configuration and re-evaluate perception for the new configuration.

Rule-based analysis of perception performance allows the high level evaluation of how errors or limitations in the perception system could influence decision making. By creating rules which assess if a maneuver would be considered safe, the decision making of an autonomous driving system in the presence of perception errors can be assessed for this maneuver. This allows evaluation of issues caused by limitations of a perception system in advance of completion of a feature within an autonomous driving system or road testing, as it is based only on the perception output and the defined rules.

An advantage of rule-based analysis of perception over evaluation of trajectories planned by a planner of an autonomous vehicle stack is that the rules are defined so as to continuously evaluate the safety of making, e.g. a lane change, whereas a lane change is only evaluated for a planner when the planner decides to plan a trajectory with a lane change maneuver. This provides better coverage in the evaluation of the perception output since the lane change is evaluated at all points of the scenario, which enables more discrepancies to be identified between the perception model and ground truth. For example, it may be the case that at a certain point in a scenario, according to a defined rule applied to a perception output, a lane change is safe. If the ground truth indicates that according to the defined rule, a lane change is not safe at the given point, then this is indicative of a perception problem which could affect the ego's decision-making. However, a planner may never plan a trajectory in which a lane change occurs at this point and therefore this would not be tested in planner evaluation.

Another advantage is speed of development. Driving rules are generally high level, and can be seen as a form of pseudo-code. As such, driving rules can be implemented earlier (e.g. the APSICE V model) at requirements stage rather than later development stages. Sensor positions are a one example of this requirements setting stage.

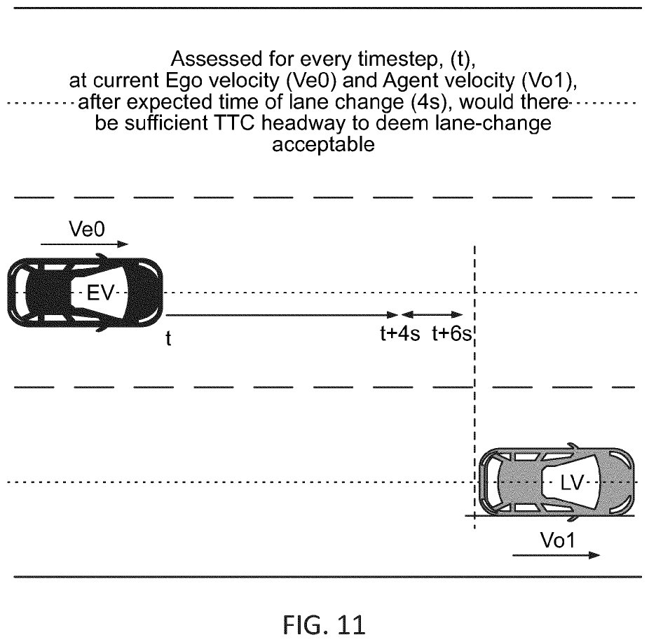

A desire in the automotive industry is to move from the V model which is very slow, but very safe to something more modern and fast. Whether that is feasible remains to be seen, but the present techniques can in any event increase the speed of developments. FIG. 11 shows an example event defined within a rule language and used to evaluate ground truth scenarios and perception model outputs. The rule specifies that given the velocity of the ego and the velocity of the agent at each timestep of the scenario, and assuming that the lane change is executed within 4 seconds with the respective velocities remaining constant, then if there is longitudinal distance between the two vehicles above a certain threshold at the end of the maneuver the lane change is safe. If the distance between the vehicles is less than the given threshold then it is deemed unsafe. Two different events may be defined which evaluate the safety of moving into the offside lane and the nearside lane respectively.

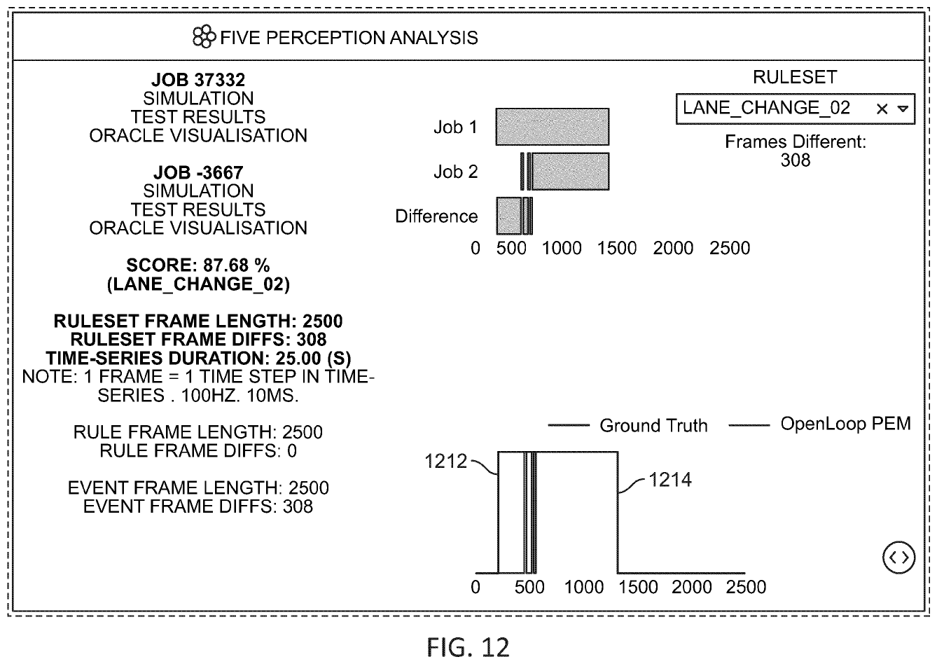

FIG. 12 shows a user interface displaying a comparison of the evaluation results for a lane change rule applied to ground truth, with the evaluation results for the same rule applied to a perception output during a scenario of 2500 frames, with the rule being evaluated at each frame. A set of bars are shown with the ground truth evaluation shown as the top bar (Job 1), and the perception output evaluation shown as the second bar (Job 2). The third bar shows in the frames for which the results differed between the two. The same comparison is shown in a line graph below. The perception output evaluation 1214 is shown alongside the ground truth 1212, where the rule evaluation result changes for the ground truth before that of the perception error model output. A score is computed based on the percentage of frames in which the rule evaluation results match for perception and ground truth and output to the user interface.

The embodiment described above uses a perception error model as a surrogate perception system for the perception setup to be tested. However, in alternative embodiments, the perception results to be evaluated may be generated by applying a real perception system to simulated sensor data. In this case, the same techniques described above may be used to assess the perception output by applying one or more rules and comparing the results with the same rules applied to a ground truth of the scenario.

The embodiment above describes evaluation of perception outputs by identifying errors which are important for planning actions, so as to determine a perception configuration which is suitable for implementing in a vehicle stack which bases planning decisions on such a perception output. As described above, differences between rule evaluations for the scenario ground truth and rule evaluations for the perception outputs could indicate that the perception system has errors which are significant for planning the particular action evaluated by a given rule. However, for a binary rule, there are two ways in which the two rule evaluations can differ. Taking a simple example based on the lane change action described above, at a given sequence of timesteps, the evaluation of the ground truth may indicate that it is unsafe to change lane for a set of timesteps and from time onwards, the rule indicates that a lane change is safe. If the perception system over the same set of timesteps indicates that the lane change action is unsafe for a longer set of timesteps, then there are timesteps where the perception outputs evaluate to ‘unsafe’ while the ground truth indicates that a lane change is safe. This may be referred to as ‘hesitation’, where an error in the perception outputs would cause the decision-making to be more cautious than the real scenario requires. However, where the perception outputs are evaluated to indicate that a lane change is ‘unsafe’ for a set of timesteps and that all timesteps from onwards are evaluated as ‘safe’, then there are timesteps in which a lane change is deemed ‘safe’ based on the perception output where the ground truth indicates that it is actually unsafe. This case could indicate a perception error which causes the decision-making to make unsafe lane-change decisions, in contrast with the ‘hesitation’ case described above.

The rules of the embodiment described above are defined to test the safety of certain actions of an ego vehicle based on the perceived state of the scenario. However, other types of decision-making may be carried out based on the perception of a scenario, and these types of decisions may be defined in the rule language mentioned above. One example application uses perception outputs to determine driver attentiveness. While this is related to safety, it is not a direct assessment of the safety of a given driving action, such as the lane change event discussed earlier. Instead, a rule is defined which uses perception to determine whether or not a human driver's attention is directed to driving, and to trigger if the driver's attention is diverted away, for example if a driver falls asleep at the wheel. In this case, the perception setup may include one or more internal sensors, such as cameras inside the vehicle to capture the driver. A rule for driver attentiveness may be based on defined requirements for autonomous driving systems, such as those set out for ALKS, and may be defined so as to satisfy those requirements. To determine driver inattentiveness, a rule may be applied to perception outputs which include, for example, the direction of the driver's gaze based on one or more criteria, such as a requirement for the driver to be looking in a direction consistent with the driving task. The rule should not trigger every time a driver looks momentarily to the left or right. As above, the rule is evaluated based on the perception output, which as mentioned above may be a PEM applied to a simulated ground truth description of the scenario, or a real perception applied to high-fidelity simulations of sensor data. The rule is binary and for each frame or timestep being evaluated, the output for that timestep is whether the driver is attentive or inattentive at that frame. As above, the perception system may be evaluated by comparing the set of rule outputs for the perception system to the set of rule outputs obtained by applying the same rule to a ground truth version of the scenario, wherein the ground truth provides the true state of the driver at each frame.

Note that evaluating these rules does not require actually implementing any driver inattentiveness monitoring within a real or simulated vehicle stack such that any intervention can be taken. As above, the perception is evaluated in an ‘open-loop’ manner such that the scenario has no dependence on the perception output or the evaluation of the rules. However, differences between the perception system and the ground truth rule outputs are indicative of an issue in perception which may cause difficulty if attempting to build an autonomous vehicle stack which does include some form of driver inattentiveness monitoring on the basis of the given perception configuration. If, at some timesteps, the ground truth assessment finds that the driver is not attentive, while the assessment of the perception outputs finds that the driver is attentive, then this is indicative that the perception system has errors which could be significant for implementing a driver inattentiveness monitoring based on that perception system.

A second application which may use perception outputs in decision making is emergency airbag deployment. An emergency airbag deployment system could be used to determine whether or not an emergency airbag should be deployed based on the state of the driving scenario given by the perception system. In this case, it would be useful to evaluate perception outputs representative of the given perception system, such as outputs of a PEM as described above, against a rule determining whether to action an emergency airbag deployment. As above, the perception system can be scored based on the extent to which the evaluation of the airbag deployment rule diverges between the perception output and the ground truth state for a scenario. This enables the perception configuration modelled by the perception outputs to be adjusted so that it produces more useful perception outputs for any eventual perception-dependent airbag deployment system that may be implemented.

The above example use cases for perception evaluation use rules which evaluate to binary outcomes (safe/unsafe, deploy airbag/do not deploy airbag, etc. However, some decision-making based on perception may be non-binary, requiring rules which evaluate to one of a set of multiple outcomes, or to a continuous value. One example is emergency braking, which can be implemented by priming the brakes in dependence on the state of the scenario. The brakes are ‘primed’ to a different degree depending on how quickly the braking is required. In some situations, the emergency brake needs to be deployed immediately, in which case no prior deceleration is required, while in other situations it may be possible to first decelerate and then deploy a full emergency brake. The degree to which the vehicle is decelerated before deploying an emergency brake can be determined using a rule based on the perceived state of the system. This rule would have multiple possible outputs, rather than just two, each output corresponding to a different degree of ‘priming’ of the brakes. To measure the difference between the ground truth and a perception output assessed for continuous or categorical rule outputs, different metrics could be used. For example, if a rule evaluates to a continuous numerical value, an aggregation of the absolute difference between the evaluation of the ground truth and that of the perception output may be computed as an overall score for the perception system on the given scenario. For categorical rule outputs, this could also evaluate a percentage of the scenario where the categories differ between the ground truth and the perception output, as described above for binary rule outputs.

The terms ‘rule’ and ‘rule-based framework’ are used broadly herein to include driving rules that need to be satisfied for safe driving, as described in more detail below, as well as ‘events’ as used for evaluating a perception system at a given snapshot. An example event, as mentioned above, is ‘safe to change lane’, where the conditions used to decide on this event for a given snapshot may specify a particular minimum longitudinal distance to other agents in the target lane. Both driving rules and events may be defined by a set of conditions specified in the rule language of the rule-based framework described below and implemented by a test oracle to evaluate an AV stack.

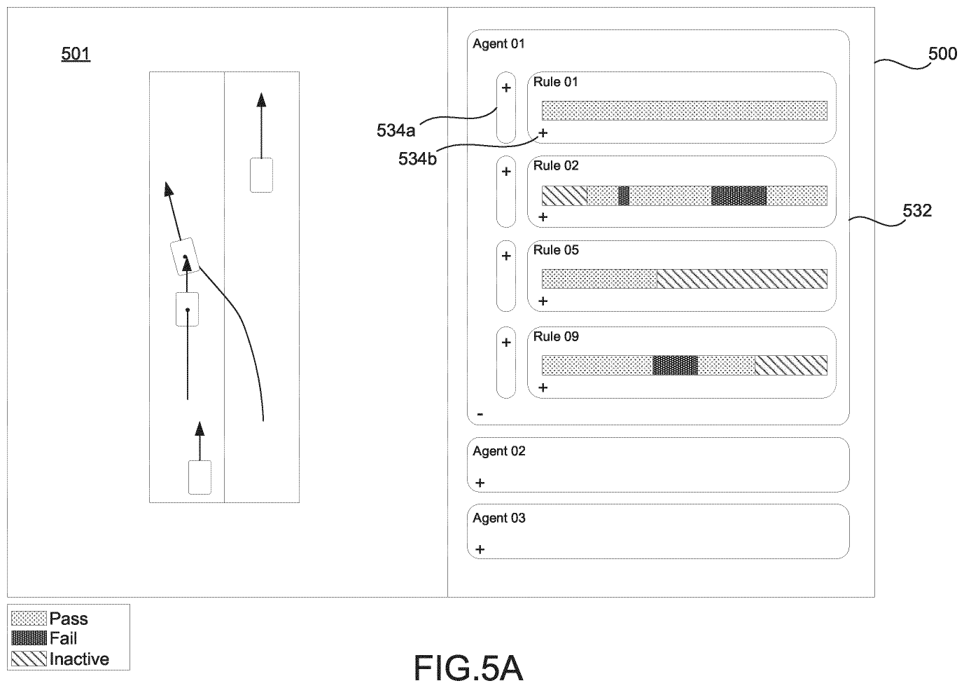

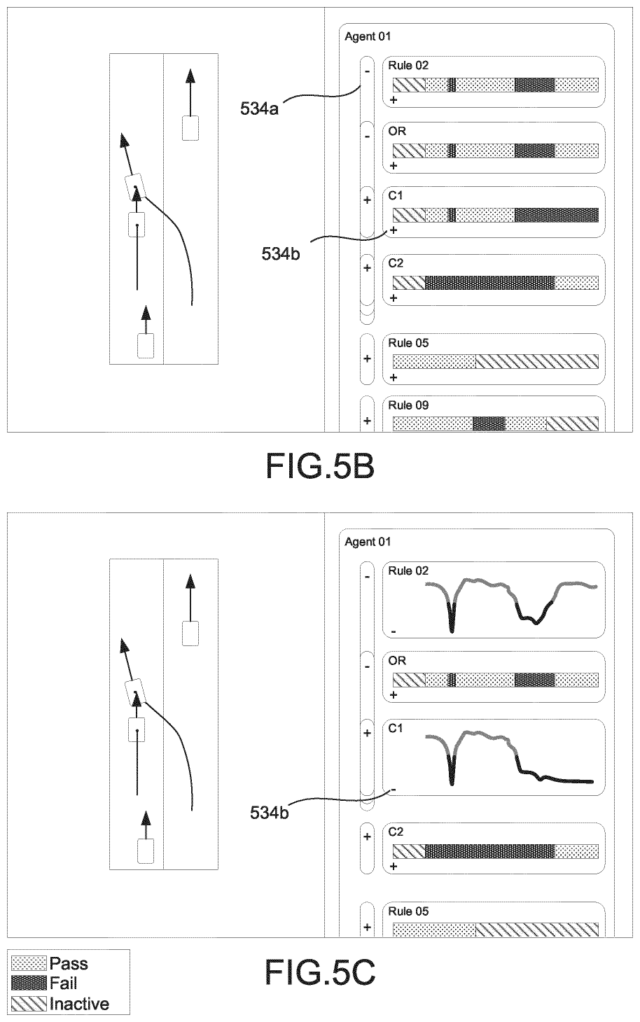

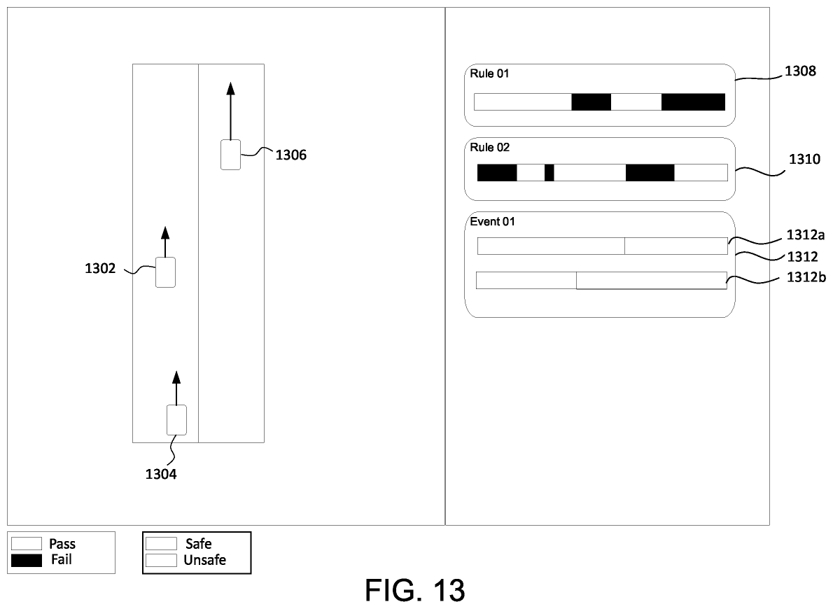

FIG. 13 shows an example graphical user interface 500 in which both driving rules and events are presented. The GUI 500 is described in further detail in an AV testing context with respect to FIGS. 5-5C. The user interface shows a scenario containing multiple agents including an ego agent 1302. In the present example, both results of driving rules applicable to the actual trace of the ego agent 1302 and results of a ‘lane change safe’ event evaluated at each snapshot of the event are displayed in the same interface. A time-series of results is available for each of the driving rules, shown as bars 1308, 1310. Examples of rules include, for example ‘No forward collisions’, specifying that the ego should not collide with any agents in front of it, or ‘no rear collisions’, specifying that the ego vehicle should not collide with any agents behind it. In this example, driving rules are evaluated as pass/fail for the time series of ground truth ego states throughout the scenario.

The test oracle also evaluates at each time step of the scenario the conditions of an event, for example a ‘lane change safe?’ event for both the ground truth snapshot at that time step and a snapshot representative of the perception output for the perception setup to be evaluated. In this way, the dependence of the decision of whether to change lane at a given time on the given perception output can be analysed.

As mentioned above, the given decision being evaluated at each snapshot does not necessarily relate to the actual actions taken by the ego vehicle throughout the scenario. The ego may or may not make a lane change in the scenario as determined by its planning component. However, the event is evaluated at each time step in order to determine whether the perception outputs are sufficient for such a decision to be made. The lane change event is displayed as a time series of results for each snapshot, with a decision of ‘safe’ or ‘unsafe’ for the lane change at each time step. The ground truth results are shown in a bar 1312a, while the perception model results are shown by a bar 1312b. As indicated by the upward diagonal stripes, the lane change is deemed to be safe for the perception model output at an earlier timestep than for the ground truth, indicating a possible failure of the perception model to identify a source of risk. For example, a rear agent may not be visible at this point due to a lack of coverage of the rear field of view by the sensor configuration.

The user interface 500 may be used to display only driving rule evaluations for the ego and/or external agents of the scenario, as shown for example in FIGS. 5A-5C, or only events for which the perception setup is being tested. Both driving rules and events are defined and applied within a common rule-based framework described below.

Further details of an example context in which the above techniques may be implemented will now be described.

A testing pipeline to facilitate rules-based testing of mobile robot stacks in real or simulated scenarios is provided. Agent (actor) behaviour in real or simulated scenarios is evaluated by a test oracle based on defined performance evaluation rules. Such rules may evaluate different facets of safety. For example, a safety rule set may be defined to assess the performance of the stack against a particular safety standard, regulation or safety model (such as RSS), or bespoke rule sets may be defined for testing any aspect of performance. The testing pipeline is not limited in its application to safety, and can be used to test any aspects of performance, such as comfort or progress towards some defined goal. A rule editor allows performance evaluation rules to be defined or modified and passed to the test oracle. The below description mainly refers to the assessment of ground truth ego actions with respect to predefined driving rules in the context of testing the overall performance of a vehicle based on the behaviour of that vehicle. For an ego vehicle, this provides a measure of performance for the AV stack as a whole, including perception, prediction and planning. However, as described above, the same testing framework can be used to define events based on which a perception setup can be tested for its suitability to support prediction and planning functions of an AV stack.

Scenarios may be represented or defined at different levels of abstraction. More abstracted scenarios accommodate a greater degree of variation. For example, a “cut-in scenario” or a “lane change scenario” are examples of highly abstracted scenarios, characterized by a maneuver or behaviour of interest, that accommodate many variations (e.g. different agent starting locations and speeds, road layout, environmental conditions etc.). A “scenario run” refers to a concrete occurrence of an agent(s) navigating a physical context, optionally in the presence of one or more other agents. For example, multiple runs of a cut-in or lane change scenario could be performed (in the real-world and/or in a simulator) with different agent parameters (e.g. starting location, speed etc.), different road layouts, different environmental conditions, and/or different stack configurations etc. The terms “run” and “instance” are used interchangeably in this context.

In the following examples describing an AV testing context, the performance of the stack is assessed, at least in part, by evaluating the behaviour of the ego agent in the test oracle against a given set of performance evaluation rules, over the course of one or more runs. The rules are applied to “ground truth” of the (or each) scenario run which, in general, simply means an appropriate representation of the scenario run (including the behaviour of the ego agent) that is taken as authoritative for the purpose of testing. Ground truth is inherent to simulation; a simulator computes a sequence of scenario states, which is, by definition, a perfect, authoritative representation of the simulated scenario run. In a real-world scenario run, a “perfect” representation of the scenario run does not exist in the same sense; nevertheless, suitably informative ground truth can be obtained in numerous ways, e.g. based on manual annotation of on-board sensor data, automated/semi-automated annotation of such data (e.g. using offline/non-real time processing), and/or using external information sources (such as external sensors, maps etc.) etc.

The scenario ground truth typically includes a “trace” of the ego agent and any other (salient) agent(s) as applicable. A trace is a history of an agent's location and motion over the course of a scenario. There are many ways a trace can be represented. Trace data will typically include spatial and motion data of an agent within the environment. The term is used in relation to both real scenarios (with real-world traces) and simulated scenarios (with simulated traces). The trace typically records an actual trajectory realized by the agent in the scenario. With regards to terminology, a “trace” and a “trajectory” may contain the same or similar types of information (such as a series of spatial and motion states over time). The term trajectory is generally favoured in the context of planning (and can refer to future/predicted trajectories), whereas the term trace is generally favoured in relation to past behaviour in the context of testing/evaluation.

In a simulation context, a “scenario description” is provided to a simulator as input. For example, a scenario description may be encoded using a scenario description language (SDL), or in any other form that can be consumed by a simulator. A scenario description is typically a more abstract representation of a scenario, that can give rise to multiple simulated runs. Depending on the implementation, a scenario description may have one or more configurable parameters that can be varied to increase the degree of possible variation. The degree of abstraction and parameterization is a design choice. For example, a scenario description may encode a fixed layout, with parameterized environmental conditions (such as weather, lighting etc.). Further abstraction is possible, however, e.g. with configurable road parameter(s) (such as road curvature, lane configuration etc.). The input to the simulator comprises the scenario description together with a chosen set of parameter value(s) (as applicable). The latter may be referred to as a parameterization of the scenario. The configurable parameter(s) define a parameter space (also referred to as the scenario space), and the parameterization corresponds to a point in the parameter space. In this context, a “scenario instance” may refer to an instantiation of a scenario in a simulator based on a scenario description and (if applicable) a chosen parameterization.

For conciseness, the term scenario may also be used to refer to a scenario run, as well a scenario in the more abstracted sense. The meaning of the term scenario will be clear from the context in which it is used.

Trajectory planning is an important function in the present context, and the terms “trajectory planner”, “trajectory planning system” and “trajectory planning stack” may be used interchangeably herein to refer to a component or components that can plan trajectories for a mobile robot into the future. Trajectory planning decisions ultimately determine the actual trajectory realized by the ego agent (although, in some testing contexts, this may be influenced by other factors, such as the implementation of those decisions in the control stack, and the real or modelled dynamic response of the ego agent to the resulting control signals).

A trajectory planner may be tested in isolation, or in combination with one or more other systems (e.g. perception, prediction and/or control). Within a full stack, planning generally refers to higher-level autonomous decision-making capability (such as trajectory planning), whilst control generally refers to the lower-level generation of control signals for carrying out those autonomous decisions. However, in the context of performance testing, the term control is also used in the broader sense. For the avoidance of doubt, when a trajectory planner is said to control an ego agent in simulation, that does not necessarily imply that a control system (in the narrower sense) is tested in combination with the trajectory planner.

### Example AV Stack:

To provide relevant context to the described embodiments, further details of an example form of AV stack will now be described.

FIG. 1A shows a highly schematic block diagram of an AV runtime stack 100. The run time stack 100 is shown to comprise a perception (sub-)system 102, a prediction (sub-)system 104, a planning (sub-)system (planner) 106 and a control (sub-)system (controller) 108. As noted, the term (sub-)stack may also be used to describe the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

Note, there may be a distinction between a planned trajectory at a given time instant, and the actual trajectory followed by the ego agent. Planning systems typically operate over a sequence of planning steps, updating the planned trajectory at each planning step to account for any changes in the scenario since the previous planning step (or, more precisely, any changes that deviate from the predicted changes). The planning system 106 may reason into the future, such that the planned trajectory at each planning step extends beyond the next planning step. Any individual planned trajectory may, therefore, not be fully realized (if the planning system 106 is tested in isolation, in simulation, the ego agent may simply follow the planned trajectory exactly up to the next planning step; however, as noted, in other real and simulation contexts, the planned trajectory may not be followed exactly up to the next planning step, as the behaviour of the ego agent could be influenced by other factors, such as the operation of the control system 108 and the real or modelled dynamics of the ego vehicle). In many testing contexts, the actual trajectory of the ego agent is what ultimately matters; in particular, whether the actual trajectory is safe, as well as other factors such as comfort and progress. However, the rules-based testing approach herein can also be applied to planned trajectories (even if those planned trajectories are not fully or exactly realized by the ego agent). For example, even if the actual trajectory of an agent is deemed safe according to a given set of safety rules, it might be that an instantaneous planned trajectory was unsafe; the fact that the planner 106 was considering an unsafe course of action may be revealing, even if it did not lead to unsafe agent behaviour in the scenario. Instantaneous planned trajectories constitute one form of internal state that can be usefully evaluated, in addition to actual agent behaviour in the simulation. Other forms of internal stack state can be similarly evaluated.

The example of FIG. 1A considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 1A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

It will be appreciated that the term “stack” encompasses software, but can also encompass hardware. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

### Example Testing Paradigm:

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step S125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance through the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (trace(s) and contextual data) for the real-world run. As discussed, the ground-truthing process could be based on manual annotation of the ‘raw’ run data 140, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a more abstracted scenario description 148 that can be used for the purpose of simulation. The scenario description 148 is consumed by the simulator 202, allowing multiple simulated runs to be performed. The simulated runs are variations of the original real-world run, with the degree of possible variation determined by the extent of abstraction. Ground truth 150 is provided for each simulated run.

In the present off-board content, there is no requirement for the traces to be extracted in real-time (or, more precisely, no need for them to be extracted in a manner that would support real-time planning); rather, the traces are extracted “offline”. Examples of offline perception algorithms include non-real time and non-causal perception algorithms. Offline techniques contrast with “on-line” techniques that can feasibly be implemented within an AV stack 100 to facilitate real-time planning/decision making.

For example, it is possible to use non-real time processing, which cannot be performed on-line due to hardware or other practical constraints of an AV's onboard computer system. For example, one or more non-real time perception algorithms can be applied to the real-world run data 140 to extract the traces. A non-real time perception algorithm could be an algorithm that it would not be feasible to run in real time because of the computation or memory resources it requires.

It is also possible to use “non-causal” perception algorithms in this context. A non-causal algorithm may or may not be capable of running in real-time at the point of execution, but in any event could not be implemented in an online context, because it requires knowledge of the future. For example, a perception algorithm that detects an agent state (e.g. location, pose, speed etc.) at a particular time instant based on subsequent data could not support real-time planning within the stack 100 in an on-line context, because it requires knowledge of the future (unless it was constrained to operate with a short look ahead window). For example, filtering with a backwards pass is a non-causal algorithm that can sometimes be run in real-time, but requires knowledge of the future.

The term “perception” generally refers to techniques for perceiving structure in the real-world data 140, such as 2D or 3D bounding box detection, location detection, pose detection, motion detection etc. For example, a trace may be extracted as a time-series of bounding boxes or other spatial states in 3D space or 2D space (e.g. in a birds-eye-view frame of reference), with associated motion information (e.g. speed, acceleration, jerk etc.). In the context of image processing, such techniques are often classed as “computer vision”, but the term perception encompasses a broader range of sensor modalities.

### Testing Pipeline:

Further details of the testing pipeline and the test oracle 252 will now be described. The examples that follow focus on simulation-based testing. However, as noted, the test oracle 252 can equally be applied to evaluate stack performance on real scenarios, and the relevant description below applies equally to real scenarios. The following description refers to the stack 100 of FIG. 1A by way of example. However, as noted, the testing pipeline 200 is highly flexible and can be applied to any stack or sub-stack operating at any level of autonomy.

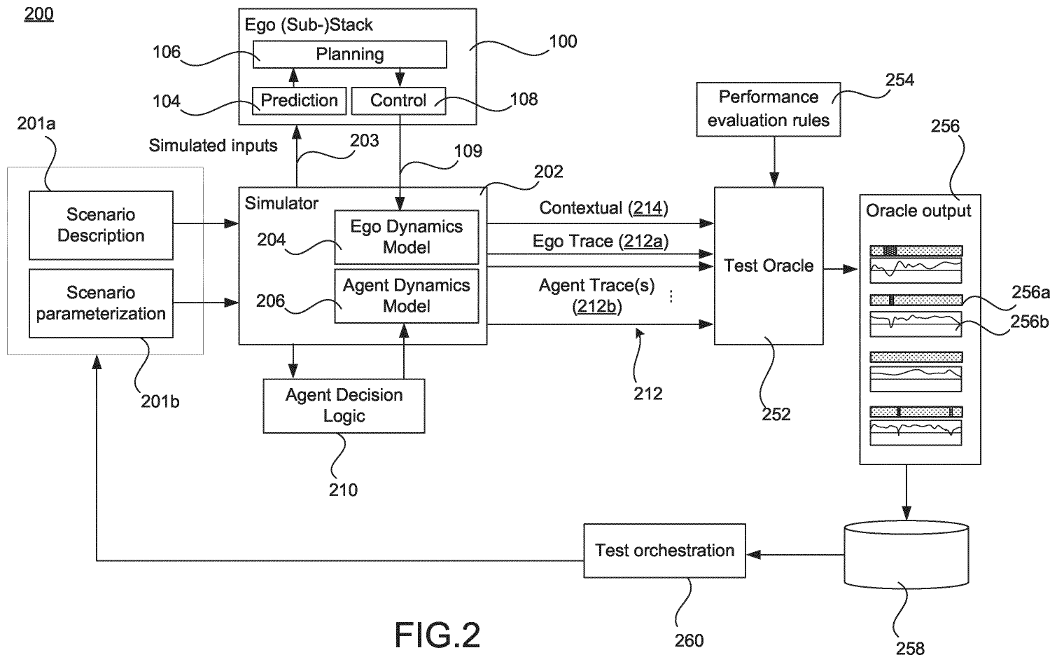

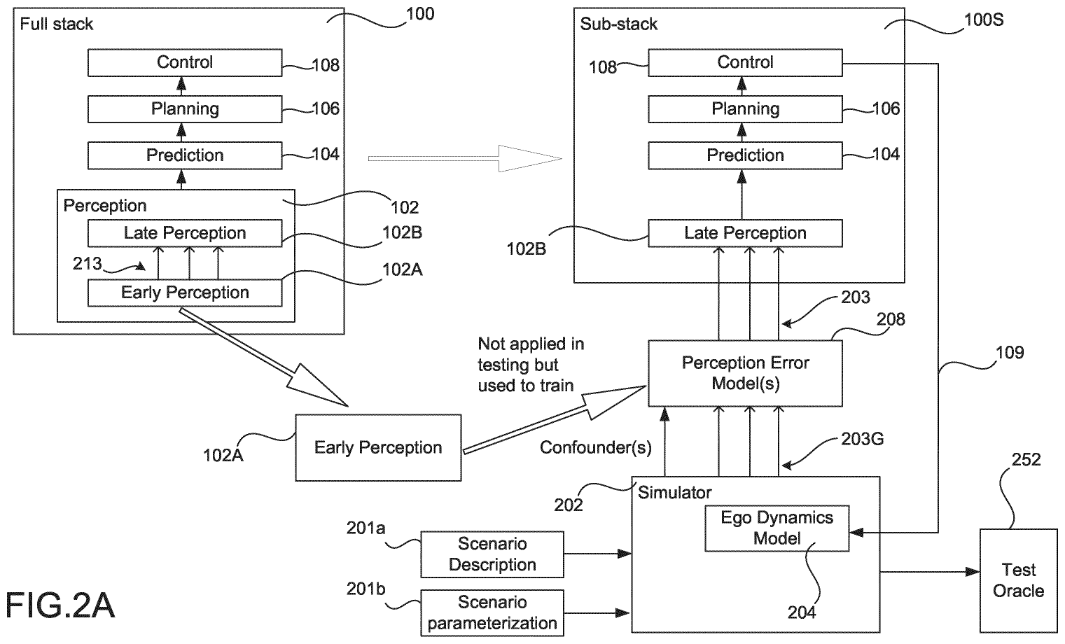

FIG. 2 shows a schematic block diagram of the testing pipeline, denoted by reference numeral 200. The testing pipeline 200 is shown to comprise the simulator 202 and the test oracle 252. The simulator 202 runs simulated scenarios for the purpose of testing all or part of an AV run time stack 100, and the test oracle 252 evaluates the performance of the stack (or sub-stack) on the simulated scenarios. As discussed, it may be that only a sub-stack of the run-time stack is tested, but for simplicity, the following description refers to the (full) AV stack 100 throughout. However, the description applies equally to a sub-stack in place of the full stack 100. The term “slicing” is used herein to the selection of a set or subset of stack components for testing.

As described previously, the idea of simulation-based testing is to run a simulated driving scenario that an ego agent must navigate under the control of the stack 100 being tested. Typically, the scenario includes a static drivable area (e.g. a particular static road layout) that the ego agent is required to navigate, typically in the presence of one or more other dynamic agents (such as other vehicles, bicycles, pedestrians etc.). To this end, simulated inputs 203 are provided from the simulator 202 to the stack 100 under testing.

The slicing of the stack dictates the form of the simulated inputs 203. By way of example, FIG. 2 shows the prediction, planning and control systems 104, 106 and 108 within the AV stack 100 being tested. To test the full AV stack of FIG. 1A, the perception system 102 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning systems 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario (i.e. “perfect” predictions).

Between these extremes, there is scope for many different levels of input slicing, e.g. testing only a subset of the perception system 102, such as “later” (higher-level) perception components, e.g. components such as filters or fusion components which operate on the outputs from lower-level perception components (such as object detectors, bounding box detectors, motion detectors etc.).

Whatever form they take, the simulated inputs 203 are used (directly or indirectly) as a basis for decision-making by the planner 108. The controller 108, in turn, implements the planner's decisions by outputting control signals 109. In a real-world context, these control signals would drive the physical actor system 112 of AV. In simulation, an ego vehicle dynamics model 204 is used to translate the resulting control signals 109 into realistic motion of the ego agent within the simulation, thereby simulating the physical response of an autonomous vehicle to the control signals 109.

Alternatively, a simpler form of simulation assumes that the ego agent follows each planned trajectory exactly between planning steps. This approach bypasses the control system 108 (to the extent it is separable from planning) and removes the need for the ego vehicle dynamic model 204. This may be sufficient for testing certain facets of planning.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour if appropriate.

A scenario is run in accordance with a scenario description 201a and (if applicable) a chosen parameterization 201b of the scenario. A scenario typically has both static and dynamic elements which may be “hard coded” in the scenario description 201a or configurable and thus determined by the scenario description 201a in combination with a chosen parameterization 201b. In a driving scenario, the static element(s) typically include a static road layout.

The dynamic element(s) typically include one or more external agents within the scenario, such as other vehicles, pedestrians, bicycles etc.

The extent of the dynamic information provided to the simulator 202 for each external agent can vary. For example, a scenario may be described by separable static and dynamic layers. A given static layer (e.g. defining a road layout) can be used in combination with different dynamic layers to provide different scenario instances. The dynamic layer may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 210 might be permitted to reduce the speed of the external agent below the target at any point along the path in order to maintain a target headway from a forward vehicle.

As will be appreciated, scenarios can be described for the purpose of simulation in many ways, with any degree of configurability. For example, the number and type of agents, and their motion information may be configurable as part of the scenario parameterization 201b.

The output of the simulator 202 for a given simulation includes an ego trace 212a of the ego agent and one or more agent traces 212b of the one or more external agents (traces 212). Each trace 212a, 212b is a complete history of an agent's behaviour within a simulation having both spatial and motion components. For example, each trace 212a, 212b may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “contextual” data 214. The contextual data 214 pertains to the physical context of the scenario, and can have both static components (such as road layout) and dynamic components (such as weather conditions to the extent they vary over the course of the simulation). To an extent, the contextual data 214 may be “passthrough” in that it is directly defined by the scenario description 201a or the choice of parameterization 201b, and is thus unaffected by the outcome of the simulation. For example, the contextual data 214 may include a static road layout that comes from the scenario description 201a or the parameterization 201b directly. However, typically the contextual data 214 would include at least some elements derived within the simulator 202. This could, for example, include simulated environmental data, such as weather data, where the simulator 202 is free to change weather conditions as the simulation progresses. In that case, the weather data may be time-dependent, and that time dependency will be reflected in the contextual data 214.

The test oracle 252 receives the traces 212 and the contextual data 214, and scores those outputs in respect of a set of performance evaluation rules 254. The performance evaluation rules 254 are shown to be provided as an input to the test oracle 252. These may be applied along with a set of predefined events as discussed above in the context of perception configuration testing.

The rules 254 are categorical in nature (e.g. pass/fail-type rules). Certain performance evaluation rules are also associated with numerical performance metrics used to “score” trajectories (e.g. indicating a degree of success or failure or some other quantity that helps explain or is otherwise relevant to the categorical results). The evaluation of the rules 254 is time-based—a given rule may have a different outcome at different points in the scenario. The scoring is also time-based: for each performance evaluation metric, the test oracle 252 tracks how the value of that metric (the score) changes over time as the simulation progresses. The test oracle 252 provides an output 256 comprising a time sequence 256a of categorical (e.g. pass/fail) results for each rule, and a score-time plot 256b for each performance metric, as described in further detail later. The results and scores 256a, 256b are informative to the expert 122 and can be used to identify and mitigate performance issues within the tested stack 100. The test oracle 252 also provides an overall (aggregate) result for the scenario (e.g. overall pass/fail). The output 256 of the test oracle 252 is stored in a test database 258, in association with information about the scenario to which the output 256 pertains. For example, the output 256 may be stored in association with the scenario description 210a (or an identifier thereof), and the chosen parameterization 201b. As well as the time-dependent results and scores, an overall score may also be assigned to the scenario and stored as part of the output 256. For example, an aggregate score for each rule (e.g. overall pass/fail) and/or an aggregate result (e.g. pass/fail) across all of the rules 254.

FIG. 2A illustrates another choice of slicing and uses reference numerals 100 and 100S to denote a full stack and sub-stack respectively. It is the sub-stack 100S that would be subject to testing within the testing pipeline 200 of FIG. 2.

A number of “later” perception components 102B form part of the sub-stack 100S to be tested and are applied, during testing, to simulated perception inputs 203. The later perception components 102B could, for example, include filtering or other fusion components that fuse perception inputs from multiple earlier perception components.

In the full stack 100, the later perception components 102B would receive actual perception inputs 213 from earlier perception components 102A. For example, the earlier perception components 102A might comprise one or more 2D or 3D bounding box detectors, in which case the simulated perception inputs provided to the late perception components could include simulated 2D or 3D bounding box detections, derived in the simulation via ray tracing. The earlier perception components 102A would generally include component(s) that operate directly on sensor data. With the slicing of FIG. 2A, the simulated perception inputs 203 would correspond in form to the actual perception inputs 213 that would normally be provided by the earlier perception components 102A. However, the earlier perception components 102A are not applied as part of the testing, but are instead used to train one or more perception error models 208 that can be used to introduce realistic error, in a statistically rigorous manner, into the simulated perception inputs 203 that are fed to the later perception components 102B of the sub-stack 100 under testing.

Such perception error models may be referred to as Perception Statistical Performance Models (PSPMs) or, synonymously, “PRISMs”. Further details of the principles of PSPMs, and suitable techniques for building and training them, may be bound in International Patent Publication Nos. WO2021037763 WO2021037760, WO2021037765, WO2021037761, and WO2021037766, each of which is incorporated herein by reference in its entirety. The idea behind PSPMs is to efficiently introduce realistic errors into the simulated perception inputs provided to the sub-stack 100S (i.e. that reflect the kind of errors that would be expected were the earlier perception components 102A to be applied in the real-world). In a simulation context, “perfect” ground truth perception inputs 203G are provided by the simulator, but these are used to derive more realistic (ablated) perception inputs 203 with realistic error introduced by the perception error models(s) 208.

As described in the aforementioned reference, a PSPM can be dependent on one or more variables representing physical condition(s) (“confounders”), allowing different levels of error to be introduced that reflect different possible real-world conditions. Hence, the simulator 202 can simulate different physical conditions (e.g. different weather conditions) by simply changing the value of a weather confounder(s), which will, in turn, change how perception error is introduced.

The later perception components 102b within the sub-stack 100S process the simulated perception inputs 203 in exactly the same way as they would process the real-world perception inputs 213 within the full stack 100, and their outputs, in turn, drive prediction, planning and control.

Alternatively, PRISMs can be used to model the entire perception system 102, including the late perception components 208, in which case a PSPM(s) is used to generate realistic perception output that are passed as inputs to the prediction system 104 directly.

Depending on the implementation, there may or may not be deterministic relationship between a given scenario parameterization 201b and the outcome of the simulation for a given configuration of the stack 100 (i.e. the same parameterization may or may not always lead to the same outcome for the same stack 100). Non-determinism can arise in various ways. For example, when simulation is based on PRISMs, a PRISM might model a distribution over possible perception outputs at each given time step of the scenario, from which a realistic perception output is sampled probabilistically. This leads to non-deterministic behaviour within the simulator 202, whereby different outcomes may be obtained for the same stack 100 and scenario parameterization because different perception outputs are sampled. Alternatively, or additionally, the simulator 202 may be inherently non-deterministic, e.g. weather, lighting or other environmental conditions may be randomized/probabilistic within the simulator 202 to a degree. As will be appreciated, this is a design choice: in other implementations, varying environmental conditions could instead be fully specified in the parameterization 201b of the scenario. With non-deterministic simulation, multiple scenario instances could be run for each parameterization. An aggregate pass/fail result could be assigned to a particular choice of parameterization 201b, e.g. as a count or percentage of pass or failure outcomes.

A test orchestration component 260 is responsible for selecting scenarios for the purpose of simulation. For example, the test orchestration component 260 may select scenario descriptions 201a and suitable parameterizations 201b automatically, based on the test oracle outputs 256 from previous scenarios.

### Test Oracle Rules:

The performance evaluation rules 254 are constructed as computational graphs (rule trees) to be applied within the test oracle. Unless otherwise indicated, the term “rule tree” herein refers to the computational graph that is configured to implement a given rule. Each rule is constructed as a rule tree, and a set of multiple rules may be referred to as a “forest” of multiple rule trees.

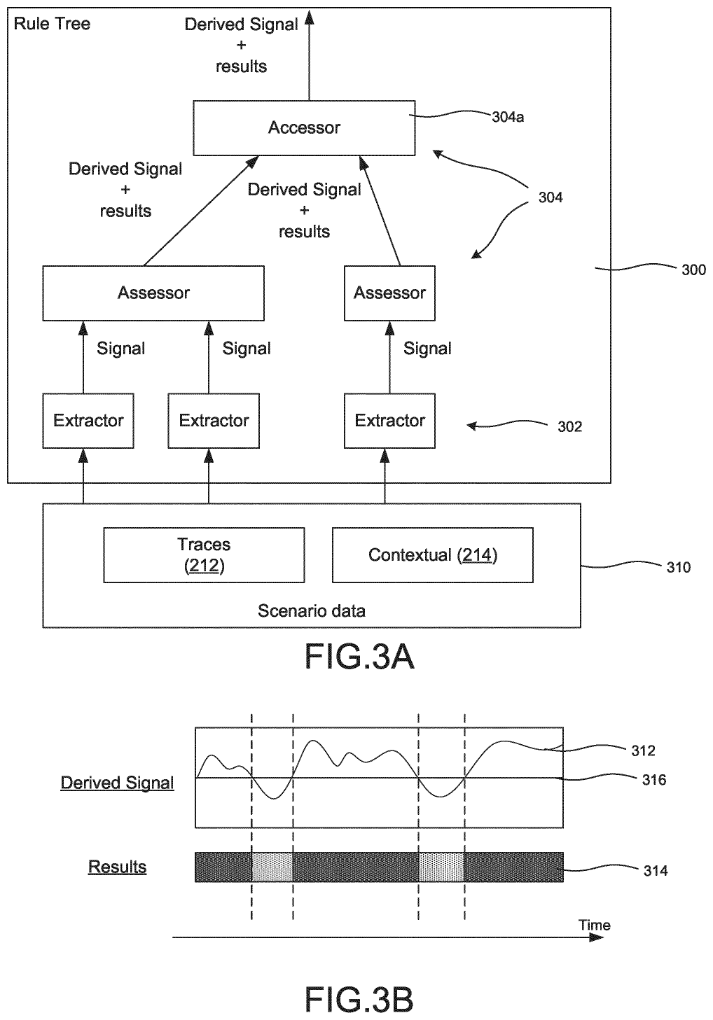

FIG. 3A shows an example of a rule tree 300 constructed from a combination of extractor nodes (leaf objects) 302 and assessor nodes (non-leaf objects) 304. Each extractor node 302 extracts a time-varying numerical (e.g. floating point) signal (score) from a set of scenario data 310. The scenario data 310 is a form of scenario ground truth, in the sense laid out above, and may be referred to as such. The scenario data 310 has been obtained by deploying a trajectory planner (such as the planner 106 of FIG. 1A) in a real or simulated scenario, and is shown to comprise ego and agent traces 212 as well as contextual data 214. In the simulation context of FIG. 2 or FIG. 2A, the scenario ground truth 310 is provided as an output of the simulator 202.

Each assessor node 304 is shown to have at least one child object (node), where each child object is one of the extractor nodes 302 or another one of the assessor nodes 304. Each assessor node receives output(s) from its child node(s) and applies an assessor function to those output(s). The output of the assessor function is a time-series of categorical results. The following examples consider simple binary pass/fail results, but the techniques can be readily extended to non-binary results. Each assessor function assesses the output(s) of its child node(s) against a predetermined atomic rule. Such rules can be flexibly combined in accordance with a desired safety model.

In addition, each assessor node 304 derives a time-varying numerical signal from the output(s) of its child node(s), which is related to the categorical results by a threshold condition (see below).

A top-level root node 304a is an assessor node that is not a child node of any other node. The top-level node 304a outputs a final sequence of results, and its descendants (i.e. nodes that are direct or indirect children of the top-level node 304a) provide the underlying signals and intermediate results.

FIG. 3B visually depicts an example of a derived signal 312 and a corresponding time-series of results 314 computed by an assessor node 304. The results 314 are correlated with the derived signal 312, in that a pass result is returned when (and only when) the derived signal exceeds a failure threshold 316. As will be appreciated, this is merely one example of a threshold condition that relates a time-sequence of results to a corresponding signal.

Signals extracted directly from the scenario ground truth 310 by the extractor nodes 302 may be referred to as “raw” signals, to distinguish from “derived” signals computed by assessor nodes 304. Results and raw/derived signals may be discretized in time.

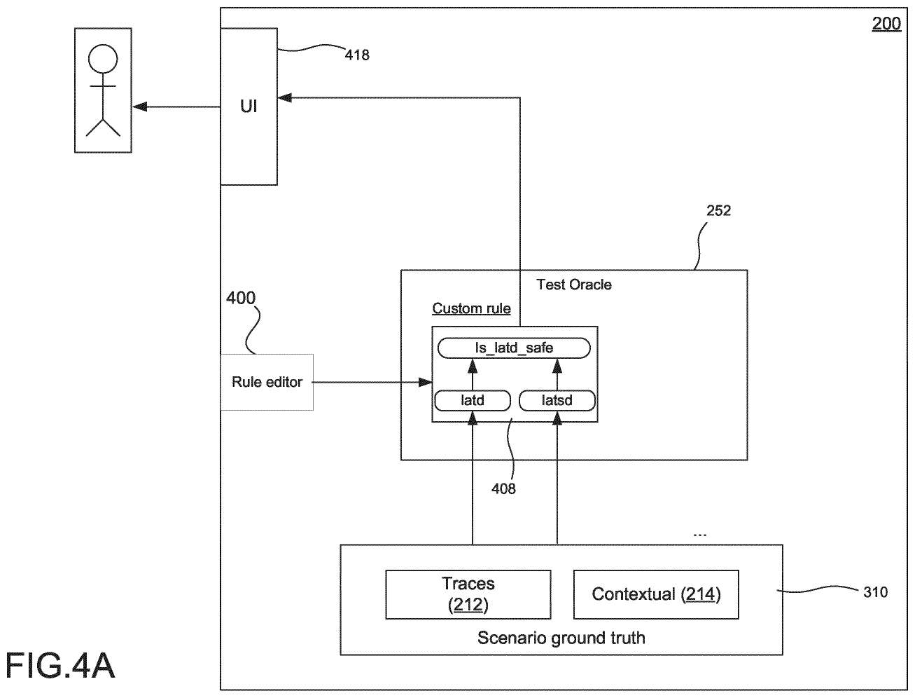

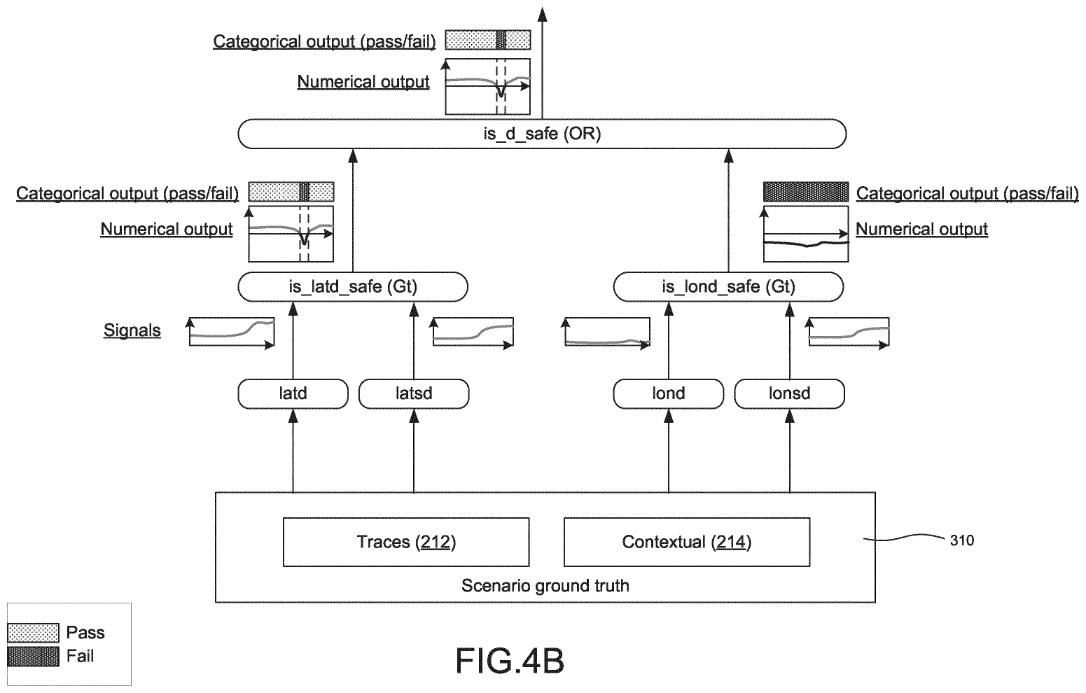

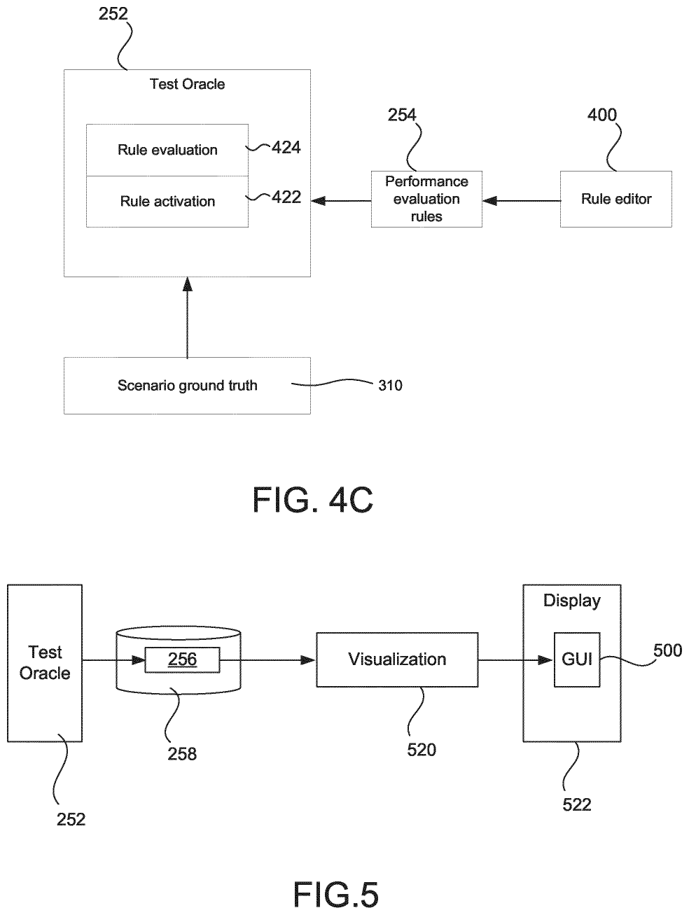

FIG. 4A shows an example of a rule tree implemented within the testing platform 200.

A rule editor 400 is provided for constructing rules to be implemented with the test oracle 252. The rule editor 400 receives rule creation inputs from a user (who may or may not be the end-user of the system). In the present example, the rule creation inputs are coded in a domain specific language (DSL) and define at least one rule graph 408 to be implemented within the test oracle 252. The rules are logical rules in the following examples, with TRUE and FALSE representing pass and failure respectively (as will be appreciated, this is purely a design choice).

The following examples consider rules that are formulated using combinations of atomic logic predicates. Examples of basic atomic predicates include elementary logic gates (OR, AND etc.), and logical functions such as “greater than”, (Gt(a,b)) (which returns TRUE when a is greater than b, and false otherwise).

A Gt function is to implement a safe lateral distance rule between an ego agent and another agent in the scenario (having agent identifier “other_agent_id”). Two extractor nodes (latd, latsd) apply LateralDistance and LateralSafeDistance extractor functions respectively. Those functions operate directly on the scenario ground truth 310 to extract, respectively, a time-varying lateral distance signal (measuring a lateral distance between the ego agent and the identified other agent), and a time-varying safe lateral distance signal for the ego agent and the identified other agent. The safe lateral distance signal could depend on various factors, such as the speed of the ego agent and the speed of the other agent (captured in the traces 212), and environmental conditions (e.g. weather, lighting, road type etc.) captured in the contextual data 214.

An assessor node (is_latd_safe) is a parent to the latd and latsd extractor nodes, and is mapped to the Gt atomic predicate. Accordingly, when the rule tree 408 is implemented, the is_latd_safe assessor node applies the Gt function to the outputs of the latd and latsd extractor nodes, in order to compute a true/false result for each timestep of the scenario, returning TRUE for each time step at which the latd signal exceeds the latsd signal and FALSE otherwise. In this manner, a “safe lateral distance” rule has been constructed from atomic extractor functions and predicates; the ego agent fails the safe lateral distance rule when the lateral distance reaches or falls below the safe lateral distance threshold. As will be appreciated, this is a very simple example of a rule tree. Rules of arbitrary complexity can be constructed according to the same principles.

The test oracle 252 applies the rule tree 408 to the scenario ground truth 310, and provides the results via a user interface (UI) 418.

FIG. 4B shows an example of a rule tree that includes a lateral distance branch corresponding to that of FIG. 4A. Additionally, the rule tree includes a longitudinal distance branch, and a top-level OR predicate (safe distance node, is_d_safe) to implement a safe distance metric. Similar to the lateral distance branch, the longitudinal distance brand extracts longitudinal distance and longitudinal distance threshold signals from the scenario data (extractor nodes lond and lonsd respectively), and a longitudinal safety assessor node (is_lond_safe) returns TRUE when the longitudinal distance is above the safe longitudinal distance threshold. The top-level OR node returns TRUE when one or both of the lateral and longitudinal distances is safe (below the applicable threshold), and FALSE if neither is safe. In this context, it is sufficient for only one of the distances to exceed the safety threshold (e.g. if two vehicles are driving in adjacent lanes, their longitudinal separation is zero or close to zero when they are side-by-side; but that situation is not unsafe if those vehicles have sufficient lateral separation).

The numerical output of the top-level node could, for example, be a time-varying robustness score.

Different rule trees can be constructed, e.g. to implement different rules of a given safety model, to implement different safety models, or to apply rules selectively to different scenarios (in a given safety model, not every rule will necessarily be applicable to every scenario; with this approach, different rules or combinations of rules can be applied to different scenarios). Within this framework, rules can also be constructed for evaluating comfort (e.g. based on instantaneous acceleration and/or jerk along the trajectory), progress (e.g. based on time taken to reach a defined goal) etc.

The above examples consider simple logical predicates evaluated on results or signals at a single time instance, such as OR, AND, Gt etc. However, in practice, it may be desirable to formulate certain rules in terms of temporal logic.

Hekmatnejad et al., “Encoding and Monitoring Responsibility Sensitive Safety Rules for Automated Vehicles in Signal Temporal Logic” (2019), MEMOCODE '19: Proceedings of the 17th ACM-IEEE International Conference on Formal Methods and Models for System Design (incorporated herein by reference in its entirety) discloses a signal temporal logic (STL) encoding of the RSS safety rules. Temporal logic provides a formal framework for constructing predicates that are qualified in terms of time. This means that the result computed by an assessor at a given time instant can depend on results and/or signal values at another time instant(s).

For example, a requirement of the safety model may be that an ego agent responds to a certain event within a set time frame. Such rules can be encoded in a similar manner, using temporal logic predicates within the rule tree.

In the above examples, the performance of the stack 100 is evaluated at each time step of a scenario. An overall test result (e.g. pass/fail) can be derived from this—for example, certain rules (e.g. safety-critical rules) may result in an overall failure if the rule is failed at any time step within the scenario (that is, the rule must be passed at every time step to obtain an overall pass on the scenario). For other types of rule, the overall pass/fail criteria may be “softer” (e.g. failure may only be triggered for a certain rule if that rule is failed over some number of sequential time steps), and such criteria may be context dependent.

FIG. 4C schematically depicts a hierarchy of rule evaluation implemented within the test oracle 252. A set of rules 254 is received for implementation in the test oracle 252.

Certain rules apply only to the ego agent (an example being a comfort rule that assesses whether or not some maximum acceleration or jerk threshold is exceeded by the ego trajectory at any given time instant).

Other rules pertain to the interaction of the ego agent with other agents (for example, a “no collision” rule or the safe distance rule considered above). Each such rule is evaluated in a pairwise fashion between the ego agent and each other agent. As another example, a “pedestrian emergency braking” rule may only be activated when a pedestrian walks out in front of the ego vehicle, and only in respect of that pedestrian agent.

Not every rule will necessarily be applicable to every scenario, and some rules may only be applicable for part of a scenario. Rule activation logic 422 within the test oracle 422 determines if and when each of the rules 254 is applicable to the scenario in question, and selectively activates rules as and when they apply. A rule may, therefore, remain active for the entirety of a scenario, may never be activated for a given scenario, or may be activated for only some of the scenario. Moreover, a rule may be evaluated for different numbers of agents at different points in the scenario. Selectively activating rules in this manner can significantly increase the efficiency of the test oracle 252.

The activation or deactivation of a given rule may be dependent on the activation/deactivation of one or more other rules. For example, an “optimal comfort” rule may be deemed inapplicable when the pedestrian emergency braking rule is activated (because the pedestrian's safety is the primary concern), and the former may be deactivated whenever the latter is active.

Rule evaluation logic 424 evaluates each active rule for any time period(s) it remains active. Each interactive rule is evaluated in a pairwise fashion between the ego agent and any other agent to which it applies.

There may also be a degree of interdependency in the application of the rules. For example, another way to address the relationship between a comfort rule and an emergency braking rule would be to increase a jerk/acceleration threshold of the comfort rule whenever the emergency braking rule is activated for at least one other agent.

Whilst pass/fail results have been considered, rules may be non-binary. For example, two categories for failure—“acceptable” and “unacceptable”—may be introduced. Again, considering the relationship between a comfort rule and an emergency braking rule, an acceptable failure on a comfort rule may occur when the rule is failed but at a time when an emergency braking rule was active. Interdependency between rules can, therefore, be handled in various ways.

The activation criteria for the rules 254 can be specified in the rule creation code provided to the rule editor 400, as can the nature of any rule interdependencies and the mechanism(s) for implementing those interdependencies.

### Graphical User Interface:

FIG. 5 shows a schematic block diagram of a visualization component 520. The visualization component is shown having an input connected to the test database 258 for rendering the outputs 256 of the test oracle 252 on a graphical user interface (GUI) 500. The GUI is rendered on a display system 522.

FIG. 5A shows an example view of the GUI 500. The view pertains to a particular scenario containing multiple agents. In this example, the test oracle output 526 pertains to multiple external agents, and the results are organized according to agent. For each agent, a time-series of results is available for each rule applicable to that agent at some point in the scenario. In the depicted example, a summary view has been selected for “Agent 01”, causing the “top-level” results computed to be displayed for each applicable rule. There are the top-level results computed at the root node of each rule tree. Colour coding is used to differentiate between periods when the rule is inactive for that agent, active and passes, and active and failed.

A first selectable element 534a is provided for each time-series of results. This allows lower-level results of the rule tree to be accessed, i.e. as computed lower down in the rule tree.

FIG. 5B shows a first expanded view of the results for “Rule 02”, in which the results of lower-level nodes are also visualized. For example, for the “safe distance” rule of FIG. 4B, the results of the “is_latd_safe node” and the “is_lond_safe” nodes may be visualized (labelled “C1” and “C2” in FIG. 5B). In the first expanded view of Rule 02, it can be seen that success/failure on Rule 02 is defined by a logical OR relationship between results C1 and C2; Rule 02 is failed only when failure is obtained on both C1 and C2 (as in the “safe distance” rule above).

A second selectable element 534b is provided for each time-series of results, that allows the associated numerical performance scores to be accessed.

FIG. 5C shows a second expanded view, in which the results for Rule 02 and the “C1” results have been expanded to reveal the associated scores for time period(s) in which those rules are active for Agent 01. The scores are displayed as a visual score-time plot that is similarly colour coded to denote pass/fail.

### Example Scenarios:

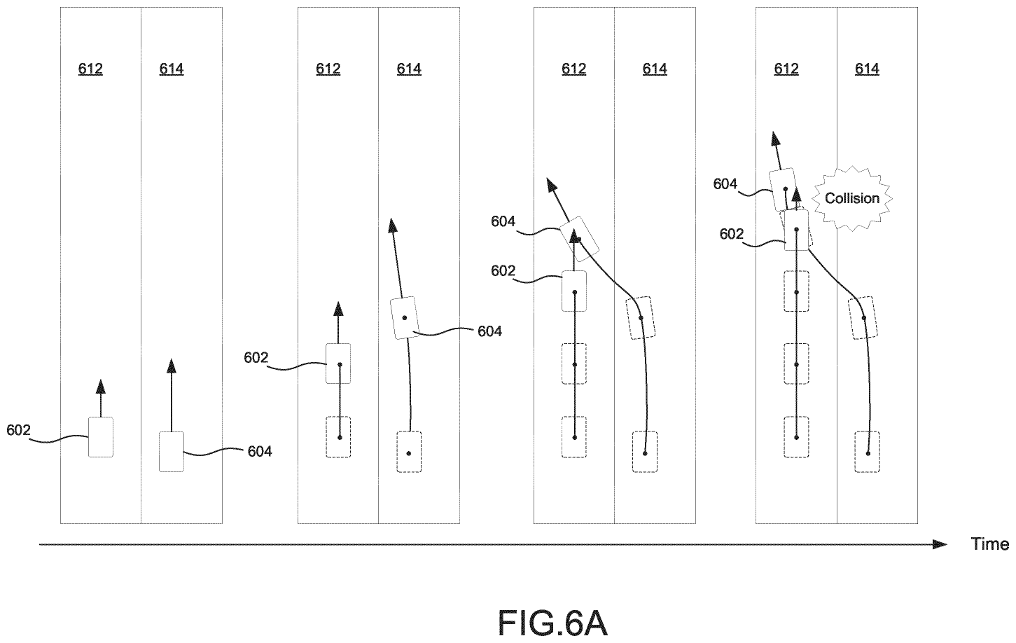

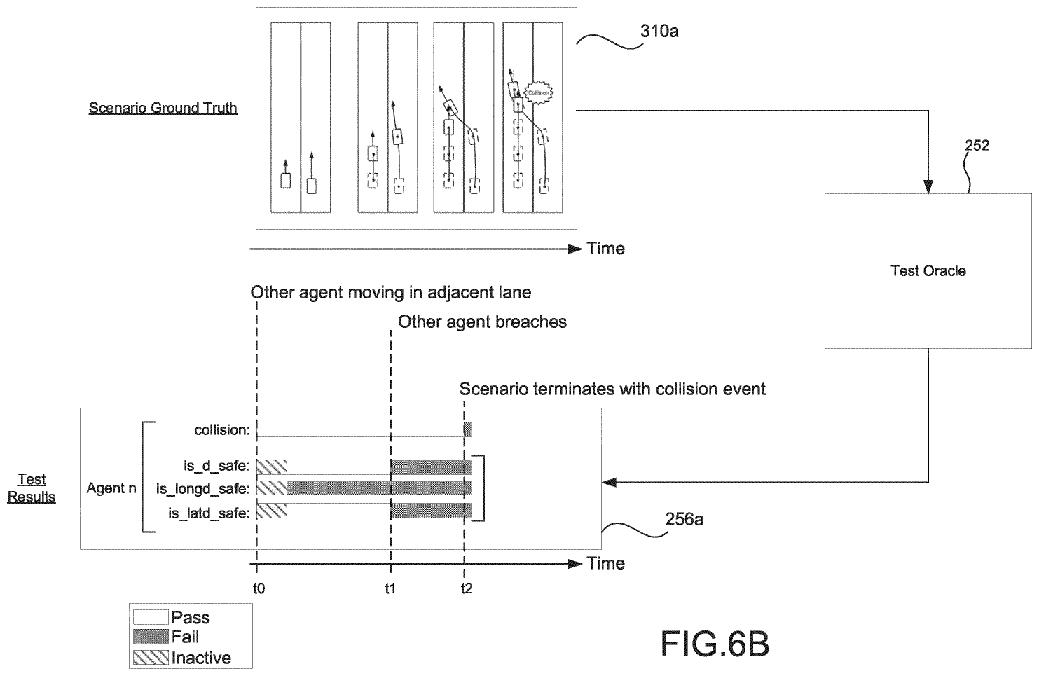

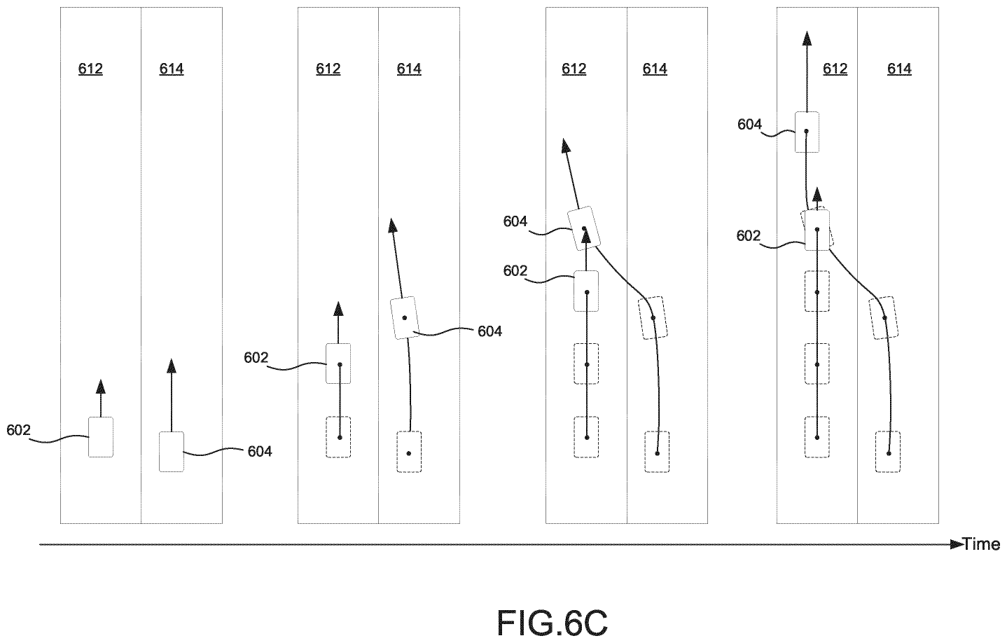

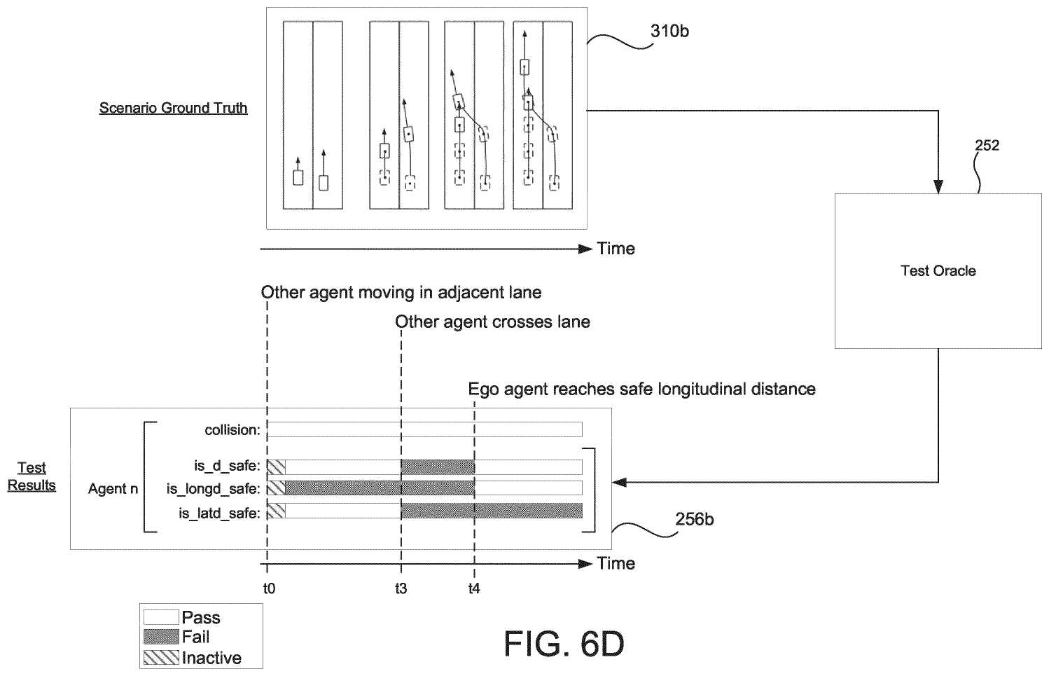

FIG. 6A depicts a first instance of a cut-in scenario in the simulator 202 that terminates in a collision event between an ego vehicle 602 and another vehicle 604. The cut-in scenario is characterized as a multi-lane driving scenario, in which the ego vehicle 602 is moving along a first lane 612 (the ego lane) and the other vehicle 604 is initially moving along a second, adjacent lane 604. At some point in the scenario, the other vehicle 604 moves from the adjacent lane 614 into the ego lane 612 ahead of the ego vehicle 602 (the cut-in distance). In this scenario, the ego vehicle 602 is unable to avoid colliding with the other vehicle 604. The first scenario instance terminates in response to the collision event.

FIG. 6B depicts an example of a first oracle output 256a obtained from ground truth 310a of the first scenario instance. A “no collision” rule is evaluated over the duration of the scenario between the ego vehicle 602 and the other vehicle 604. The collision event results in failure on this rule at the end of the scenario. In addition, the “safe distance” rule of FIG. 4B is evaluated. As the other vehicle 604 moves laterally closer to the ego vehicle 602, there comes a point in time (t1) when both the safe lateral distance and safe longitudinal distance thresholds are breached, resulting in failure on the safe distance rule that persists up to the collision event at time t2.

FIG. 6C depicts a second instance of the cut-in scenario. In the second instance, the cut-in event does not result in a collision, and the ego vehicle 602 is able to reach a safe distance behind the other vehicle 604 following the cut in event.

FIG. 6D depicts an example of a second oracle output 256b obtained from ground truth 310b of the second scenario instance. In this case, the “no collision” rule is passed throughout. The safe distance rule is breached at time t3 when the lateral distance between the ego vehicle 602 and the other vehicle 604 becomes unsafe. However, at time t4, the ego vehicle 602 manages to reach a safe distance behind the other vehicle 604. Therefore, the safe distance rule is only failed between time t3 and time t4.

Whilst the above examples consider AV stack testing, the techniques can be applied to test components of other forms of mobile robot. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable though circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack FIG. 1A may be implemented in programmable or dedicated processor(s), or a combination of both, on-board a vehicle or in an off-board computer system in the context of testing and the like. The various components of FIG. 2, such as the simulator 202 and the test oracle 252 may be similarly implemented in programmable and/or dedicated hardware.

1. A computer-implemented method of testing a candidate perception setup for an autonomous vehicle, the candidate perception setup tested using a decision making component to assess suitability of the candidate perception setup in terms of its effect on driving decisions, the method comprising:
receiving ground truth of a real or simulated driving scenario run, in which an ego agent operated independently of the decision making component and independently of the candidate perception setup;
providing, to the decision making component, a time-sequence of ground truth snapshots of the driving scenario run, wherein for each ground truth snapshot, the decision making component decides a first ego action for the ego agent, thereby determining a first time-sequence of decisions for the ground truth snapshots;
providing, to the decision making component, a time-sequence of ablated snapshots of the driving scenario run, each ablated snapshot generated based on the ground truth and the candidate perception setup, so as to cause, in the ablated snapshot, perception error that is representative of the candidate perception setup, wherein for each ablated snapshot, the decision making component decides a second ego action for the ego agent, thereby determining a second time-sequence of decisions for the ablated snapshots; and
computing a similarity measure between the first time-sequence of decisions and the second time-sequence of decisions, the similarity measure denoting an extent to which the candidate perception setup caused a change in one or more decisions points of the second time-sequence of decisions relative to the first time-sequence of decisions, a decision point occurring when a decision changes between adjacent timesteps.

2. The method according to claim 1, comprising identifying one or more first decision points in the first time-sequence of decisions and identifying one or more second decision points in the second time-sequence of decisions, and comparing the one or more first decision points with the one or more second decision points to compute the similarity measure.

3. The method according to claim 1, wherein the similarity measure implicitly captures information about the one or more decision points based on a comparison between each decision of the first time-sequence of decisions and a corresponding decision of the second time-sequence of decisions.

4. The method according to claim 3, wherein the similarity measure is computed as a sum of differences between the first time-sequence of decisions and the second time-sequence of decisions.

5. The method according to claim 1, wherein the first time-sequence of decisions comprises a binary indicator for the first ego action at a time step corresponding to each ground truth snapshot, and wherein the second time-sequence of decisions comprises a binary indicator for the second ego action at a time step corresponding to each ablated snapshot.

6. The method according to claim 5, wherein each decision of the first and second time-sequence of decision comprises one of:
an indicator of safety of the respective ego action for each ground truth or ablated snapshot;
an indicator of driver attentiveness for each ground truth or ablated snapshot; and
an indicator for emergency airbag deployment for each ground truth or ablated snapshot.

7. The method according to claim 1, wherein each decision of the first and second time-sequence of decisions comprises a non-binary indicator for a corresponding ego action at a time step corresponding to each ground truth or ablated snapshot.

8. The method according to claim 1, wherein the candidate perception setup is defined based on user inputs received at a graphical user interface.

9. The method according to claim 1, wherein each ablated snapshot is generated by applying the candidate perception setup to sensor-realistic synthetic sensor data generated in simulation.

10. The method according to claim 1, wherein each ablated snapshot is generated by applying a perception error model representative of the candidate perception setup to a corresponding ground truth snapshot.

11. The method according to claim 1, wherein, for each of the ground truth snapshots and ablated snapshots, the decision making component decides the first or second ego action for the ego agent based on a motion model applied to the ego agent and/or other agents of the ground truth or ablated snapshot.

12. (canceled)

13. The method according to claim 1, wherein the first and second time-sequences of decisions are used to generate an output at a user interface indicating one or more decisions points of the first time-sequence of decisions and one or more decision points of the second time-sequence of decisions.

14. A non-transitory computer readable medium embodying computer program instructions, the computer program instructions configured so as, when executed on one or more hardware processors, to implement a method comprising:
providing to a decision making component a baseline driving scene, wherein the decision making component is configured to classify a driving action based on the baseline driving scene, in relation to a predefined set of decision classes;
providing to the decision making component an ablated driving scene, which corresponds in time to the baseline driving scene, and includes perception error representative of a candidate perception setup for an autonomous vehicle, wherein the decision making component is configured to classify the driving action based on the ablated driving scene, in relation to the predefined set of decision classes; and
comparing a classification of the baseline driving scene with a classification of the ablated driving scene, to determine whether the driving action was assigned a different decision class for the ablated driving scene than the baseline driving scene.

15. The non-transitory computer readable medium of claim 14, wherein an output is generated at a user interface for showing an effect of the perception error on decision making by the decision making component, wherein the output is generated based on the comparing.

16. The non-transitory computer readable medium of claim 15, wherein the output comprises a similarity metric, indicating an extent of similarity between driving decisions based on the baseline driving scene and driving decisions based on the ablated driving scenes.

17. The non-transitory computer readable medium of claim 14, wherein the method is performed at each of multiple time steps of a driving scenario, wherein for each time step the method is performed on a baseline driving scene of a first time sequence of baseline driving scenes, and a corresponding ablated driving scene of a second time sequence of ablated driving scenes, the baseline driving scene and the corresponding ablated driving scene derived from that time step of the driving scenario.

18. The non-transitory computer readable medium of claim 17, wherein the method is performed at each of the multiple time steps of a driving scenario, wherein for each time step the method is performed on a baseline driving scene of a first time sequence of baseline driving scenes, and a corresponding ablated driving scene of a second time sequence of ablated driving scenes, the baseline driving scene and the corresponding ablated driving scene derived from that time step of the driving scenario, and wherein an output generated at a user interface is an aggregated output, computed over the multiple time steps.

19. The non-transitory computer readable medium of claim 14, wherein the method is performed over multiple scenarios, wherein a subset of one or more scenarios is identified in which an extent of difference is greatest.

20. A computer system for testing a candidate perception setup for an autonomous vehicle, the candidate perception setup tested using a decision making component to assess suitability of the candidate perception setup in terms of its effect on driving decisions, the computer system comprising:
at least one memory storing computer-readable instructions; and
at least one processor coupled to the at least one memory and configured to execute the computer-readable instructions, which upon execution cause the at least one processor to:
receive ground truth of a real or simulated driving scenario run, in which an ego agent operated independently of the decision making component and independently of the candidate perception setup;
provide, to the decision making component, a time-sequence of ground truth snapshots of the driving scenario run, wherein for each ground truth snapshot, the decision making component decides a first ego action for the ego agent, thereby determining a first time-sequence of decisions for the ground truth snapshots;
provide, to the decision making component, a time-sequence of ablated snapshots of the driving scenario run, each ablated snapshot generated based on the ground truth and the candidate perception setup, so as to cause, in the ablated snapshot, perception error that is representative of the candidate perception setup, wherein for each ablated snapshot, the decision making component decides a second ego action for the ego agent, thereby determining a second time-sequence of decisions for the ablated snapshots; and
compute a similarity measure between the first time-sequence decisions and the second time-sequence of decisions, the similarity measure denoting an extent to which the candidate perception setup caused a change in one or more decisions points of the second time-sequence of decisions relative to the first time-sequence of decisions, a decision point occurring when a decision changes between adjacent timesteps.

21. (canceled)

22. A method according to claim 1, embodied in an off-board computer system or simulator.
